(19) United States
(12) Patent Application Publication
(10) Pub. No.: US 2024/0357953 A1
(43) Pub. Date: Oct. 31, 2024

(54) COMPUTER-IMPLEMENTED METHOD FOR PROVIDING OPERATION DATA FOR TREATMENT DEVICES ON AN AGRICULTURAL FIELD, CORRESPONDING SYSTEMS, USE AND COMPUTER ELEMENT

(71) Applicant: BASF AGRO TRADEMARKS GMBH, Ludwigshafen (DE)

(72) Inventors: Holger HOFFMANN, Koeln (DE); Maik ZIES, Koeln (DE)

(21) Appl. No.: 18/571,769

(22) PCT Filed: Jun. 24, 2022
(86) PCT No.: PCT/EP2022/067382

§ 371 Date: Dec. 19, 2023

(30) Foreign Application Priority Data
Jun. 25, 2021 (EP) 21181618.6
Jun. 25, 2021 (EP) 21181620.2
Feb. 18, 2022 (EP) 22157513.7
Feb. 18, 2022 (EP) 22157516.0

(51) Int. Cl. A01B 79/00; A01M 7/00; B64U 10/13; B64U 101/40

(52) U.S. Cl. CPC A01B 79/005; A01M 7/0089; B64U 10/13; B64U 2101/40

(57) ABSTRACT

A computer-implemented method for providing operation data for treatment devices (102, 104, 106, 107) on an agricultural field (112). wherein the treatment devices include at least a first treatment device (102) and a second treatment device (104) for treating the agricultural field, the method comprising the steps: obtaining field data for at least one section (113) of the agricultural field at least by the first treatment device, wherein the obtained field data indicates a monitoring and treatment status associated with the at least one section: based on the monitoring and treatment status associated with the at least one section providing operation data associated with the at least one section of the agricultural field for the second treatment device.

### TECHNICAL FIELD

The present disclosure relates to a computer-implemented method for providing operation data for treatment devices for treating an agricultural field, a system for providing operation data for treatment devices for treating an agricultural field, uses in such a method, and a computer program element.

### TECHNICAL BACKGROUND

The general background of this disclosure is the treatment of plants in an agricultural field, which may be an agricultural field, a greenhouse, or the like. The treatment of plants, such as the cultivated crops, may also comprise the treatment of weeds present in the agricultural field, the treatment of the insects present in the agricultural field or the treatment of pathogens present in the agricultural field.

To make farming more sustainable and reduce environmental impact precision farming technology is being developed. Here a semi-automated or fully automated plant treatment device, such as a drone, a robot, a smart sprayer, or the like, may be configured to treat weeds, insects and/or the pathogens in the agricultural field based on ecological and economical rules. The technological developments in the field of drones or in robotics enable new treatment schemes for farmers.

For example, WO2019075179A1 discloses a system and method for providing individualized management for a plurality of plants. An exemplary system comprises a plurality of drones including a first drone, a docking station, and a server. The first drone is assigned to a first plant of the plurality of plants and is configured to accommodate a plurality of combinations of drone attachments. The docking station comprises a plurality of drone attachments. The server includes a database related to the plurality of plants. The database includes location information associated with the first plant. The first drone is further configured to: make a plurality of visits to the first plant, gather plant-specific information associated with the first plant, obtain a prescription based on the plant-specific information, wherein the prescription is associated with one or more requirements, based on the prescription, provide care to the first plant.

CN112015200A discloses an agricultural unmanned aerial vehicle group cooperative operation system. The system comprises a main unmanned aerial vehicle used for sending an instruction to more than one corresponding auxiliary unmanned aerial vehicle and also used for receiving position information and operation task state information from the auxiliary unmanned aerial vehicles, planning a flight route and deciding an operation task according to the received position information and operation task state information, generating an instruction according to the planned flight route and the decided operation task, and sending the instruction to the auxiliary unmanned aerial vehicles. (no see and spray)

CN108983823A The invention relates to a plant protection UAV (unmanned aerial vehicle) cluster cooperative control method. Compared with the prior art, the method irons out a defect that a plant protection UAV cluster method cannot achieve the automatic cooperative control for the agricultural pest monitoring and pesticide application. The method comprises the following steps: initialization of the UAV cluster; task overall arrangement of individual UAVs; the space overall arrangement of the individual UAVs; the motion planning of a father UAV and a son UAV; the control motion of the search of the UAV cluster in a free motion space; the detection. recognition and pesticide application through the father UAV. The method achieves the cooperative control of the plant protection UAV cluster, enables the UAV cluster to perform the automatic pesticide application after the pest recognition through a conventional mature pest image recognition method. (no see and spray)

CN107728642A discloses an unmanned plane flight control system. The unmanned plane flight control system comprises a main controller, an execution mechanism, a communication device and a ground station device. The master control system comprises a data collection module, a data processing module and a communication module. The data collection module is used for collecting measurement signals of various sensors and uploading the measurement signals to the data processing module. The data processing module can perform management and control on various flight modes and on an execution mechanism in the unmanned plane flight. The execution mechanism comprises a motor electric regulation device and a spraying device. The ground station device can perform track programming and can perform formation on multiple unmanned planes to carry out cooperated programming of multiple unmanned planes. The master controller realizes unmanned plane terrain simulation flight control, highly reliable fault tolerance control and autonomous obstacle avoidance control.

It has been found that a further need exists to provide information to control a treatment device for treating an agricultural field.

### SUMMARY OF THE INVENTION

In one aspect a computer-implemented method for providing operation data for treatment devices on an agricultural field is presented, wherein the treatment devices include at least a first treatment device and a second treatment device for treating the agricultural field, the method comprising the steps:
obtaining field data for at least one section of the agricultural field at least from the first treatment device, wherein the obtained field data indicates a monitoring and treatment status associated with the first treatment device and the at least one section;
based on the monitoring and treatment status associated with the at least one section providing operation data associated with the at least one section of the agricultural field for the second treatment device.

In a further aspect of the present disclosure a computer-implemented method for controlling operation of treatment devices on an agricultural field is presented, wherein the treatment devices include at least a first treatment device and a second treatment device for treating the agricultural field, the method comprising the steps:
obtaining field data for at least one section of the agricultural field at least from the first treatment device, wherein the obtained field data indicates a monitoring and treatment status associated with the first treatment device and the at least one section;
based on the monitoring and treatment status associated with the at least one section providing operation data associated with the at least one section of the agricultural field to the second treatment device;
controlling the operation of the second treatment device based on the provided operation data.

In a further aspect of the present disclosure a computer-implemented method for managing operation of treatment devices on an agricultural field is presented, wherein the treatment devices include at least a first treatment device and a second treatment device for treating the agricultural field, the method comprising the steps:
obtaining field data for at least one section of the agricultural field at least from the first treatment device, wherein the obtained field data indicates a monitoring and treatment status associated with the first treatment device and the at least one section;
based on the monitoring and treatment status associated with the at least one section selecting a suitable second treatment device for treatment of the at least one section of the agricultural field and providing operation data associated with the at least one section of the agricultural field for and/or to the suitable second treatment device;
optionally controlling the operation of the second treatment device based on the provided operation data.

In a further aspect a system for providing operation data for treatment devices on an agricultural field is presented, the system comprising:
at least a first treatment device and a second treatment device for treating the agricultural field;
a monitoring or obtaining unit configured to obtain field data for at least one section of the agricultural field at least from the first treatment device, wherein the obtained field data indicates a monitoring and treatment status associated with the first treatment device and the at least one section;
a providing unit configured to provide operation data associated with the at least one section of the agricultural field for the second treatment device based on the monitoring and treatment status associated with the at least one section.

In a further aspect a system for controlling operation of treatment devices on an agricultural field is presented, the system comprising:
at least a first treatment device and a second treatment device for treating the agricultural field;
a monitoring unit configured to obtain field data for at least one section of the agricultural field at least from the first treatment device, wherein the obtained field data indicates a monitoring and treatment status associated with the first treatment device and the at least one section;
a providing unit configured to provide operation data associated with the at least one section of the agricultural field to the second treatment device based on the monitoring and treatment status associated with the at least one section;
a controlling unit configured to control operation of the second treatment device based on the provided operation data.

In a further aspect a system for managing operation of treatment devices on an agricultural field is presented, the system comprising:
at least a first treatment device and a second treatment device for treating the agricultural field;
a monitoring unit configured to obtain field data for at least one section of the agricultural field at least from the first treatment device, wherein the obtained field data indicates a monitoring and treatment status associated with the first treatment device and the at least one section;
a providing unit configured to select a suitable second treatment device for treating the at least one section of the agricultural field and to provide operation data associated with the at least one section of the agricultural field for and/or to the selected second treatment device based on the monitoring and treatment status associated with the at least one section;
optionally a controlling unit configured to control operation of the second treatment device based on the provided operation data.

A system for operating treatment devices on an agricultural field, the system comprising:
at least a first treatment device and a second treatment device for treating the agricultural field;
optionally a clould environment and/or a ground station;
one or more computing device(s) configured to provide operation data for treatment devices on an agricultural field, wherein the computing device(s) include instructions, which when executed on the one ore more computing device(s) execute the following steps:
obtaining field data for at least one section of the agricultural field at least from the first treatment device, wherein the obtained field data indicates a monitoring and treatment status associated with the at least one section;
based on the monitoring and treatment status associated with the at least one section providing operation data associated with the at least one section of the agricultural field for the second treatment device; or
one or more computing device(s) configured to provide control operation of treatment devices on an agricultural field, wherein the computing devices include instructions, which when executed on the one ore more computing device(s) execute the following steps:
obtaining field data for at least one section of the agricultural field at least from the first treatment device, wherein the obtained field data indicates a monitoring and treatment status associated with the first treatment device and the at least one section;
based on the monitoring and treatment status associated with the at least one section providing operation data associated with the at least one section of the agricultural field to the second treatment device;
controlling the operation of the second treatment device based on the provided operation data;
or
one or more computing device(s) configured to manage operation of treatment devices on an agricultural field, wherein the computing devices include instructions, which when executed on the one ore more computing device(s) execute the following steps:
obtaining field data for at least one section of the agricultural field at least from the first treatment device, wherein the obtained field data indicates a monitoring and treatment status associated with the first treatment device and the at least one section;
based on the monitoring and treatment status associated with the at least one section selecting a suitable second treatment device for treatment of the at least one section of the agricultural field and providing operation data associated with the at least one section of the agricultural field for and/or to the suitable second treatment device;
optionally controlling the operation of the second treatment device based on the provided operation data.

In another aspect a computer-implemented method for providing selection data for treatment devices on an agricultural field is presented, wherein the treatment devices include at least a first treatment device and a second treatment device for treating the agricultural field, the method comprising the steps:
obtaining field data for at least one section of the agricultural field at least from the first treatment device;
based on the field data associated with the at least one section providing selection data for selecting the second treatment device associated with the at least one section of the agricultural field.

In another aspect a computer-implemented method for controlling operation of treatment devices on an agricultural field is presented, wherein the treatment devices include at least a first treatment device and a second treatment device for treating the agricultural field, the method comprising the steps:
obtaining field data for at least one section of the agricultural field at least from the first treatment device;
based on the field data associated with the at least one section providing selection data for selecting the second treatment device associated with the at least one section of the agricultural field;
controlling the operation of the treatment devices based on the provided selection data.

In another aspect a computer-implemented method for managing operation of treatment devices on an agricultural field is presented, wherein the treatment devices include at least a first treatment device and a second treatment device for treating the agricultural field, the method comprising the steps:
obtaining field data for at least one section of the agricultural field at least from the first treatment device;
based on the field data associated with the at least one section providing selection data for selecting a suitable second treatment device for treatment of the at least one section of the agricultural field and providing operation data associated with the at least one section of the agricultural field for and/or to the suitable second treatment device;
optionally controlling the operation of the second treatment device based on the provided selection and operation data.

In a further aspect a system for providing selection data for treatment devices on an agricultural field is presented, the system comprising:
at least a first treatment device and a second treatment device for treating the agricultural field;
a monitoring or obtaining unit configured to obtain field data for at least one section of the agricultural field at least from the first treatment device;
a providing unit configured to provide selection data based on the field data associated with the at least one section for selecting the second treatment device associated with the at least one section of the agricultural field.

In another aspect a system for controlling operation of treatment devices on an agricultural field is presented, the system comprising:
at least a first treatment device and a second treatment device for treating the agricultural field;
a monitoring or obtaining unit configured to obtain field data for at least one section of the agricultural field at least from the first treatment device;
a providing unit configured to provide selection data based on the field data associated with the at least one section for selecting the second treatment device associated with the at least one section of the agricultural field;
a control unit configured to control the operation of the treatment devices based on the provided selection data.

In another aspect a system for managing operation of treatment devices on an agricultural field is presented, the system comprising:
at least a first treatment device and a second treatment device for treating the agricultural field;
a monitoring or obtaining unit configured to obtain field data for at least one section of the agricultural field at least from the first treatment device;
a providing unit configured to provide selection data based on the field data associated with the at least one section for selecting a suitable second treatment device for treatment of the at least one section of the agricultural field and operation data associated with the at least one section of the agricultural field for and/or to the suitable second treatment device;
optionally a control unit configured to control the operation of the second treatment device based on the provided selection and operation data.

A system for operating treatment devices on an agricultural field, the system comprising:
at least a first treatment device and a second treatment device for treating the agricultural field;
optionally a clould environment and/or a ground station;
one or more computing device(s) configured to provide selection data for treatment devices on an agricultural field, wherein the computing device(s) include instructions, which when executed on the one ore more computing device(s) execute the following steps:
obtaining field data for at least one section of the agricultural field at least from the first treatment device;
based on the field data associated with the at least one section providing selection data for selecting the second treatment device associated with the at least one section of the agricultural field;
or
obtaining field data for at least one section of the agricultural field at least from the first treatment device;
based on the field data associated with the at least one section providing selection data for selecting the second treatment device associated with the at least one section of the agricultural field;
controlling the operation of the treatment devices based on the provided selection data;
or
obtaining field data for at least one section of the agricultural field at least from the first treatment device;
based on the field data associated with the at least one section providing selection data for selecting a suitable second treatment device for treatment of the at least
one section of the agricultural field and providing operation data associated with the at least one section of the agricultural field for and/or to the suitable second treatment device;
optionally controlling the operation of the second treatment device based on the provided selection and operation data.

In a further aspect the use of a treatment device in or for performing any one of the methods disclosed herein is presented. In another aspect a method for using a treatment device in or for performing any one of the methods disclosed herein is presented.

In a further aspect the use of operation data obtained by any one of the methods disclosed herein for operating at least one treatment device is presented. In another aspect a method for using the operation data obtained by performing any one of the methods disclosed herein for operating at least one treatment is presented.

In a further aspect a computer element, inparticular a computer program product or a computer readable medium, with instructions, which when executed on one or more computing device(s) is configured to carry out the steps of any of the methods disclosed herein in any of the systems disclosed herein is presented.

In a further aspect the use of a treatment product in any of the methods disclosed herein or in any of the systems disclosed herein is presented. In another aspect a method for treating an agricultural area is presented, the method comprising the step of providing a treatment product for use in any of the methods disclosed herein or in any of the systems disclosed herein.

### EMBODIMENTS

Any disclosure and embodiments described herein relate to the methods, the systems, the treatment devices, the computer element lined out above and vice versa. Advantageously, the benefits provided by any of the embodiments and examples equally apply to all other embodiments and examples and vice versa.

As used herein “determining” also includes “initiating or causing to determine”, “generating” also includes “initiating or causing to generate” and “providing” also includes “initiating or causing to determine, generate, select, send or receive”. “Initiating or causing to perform an action” includes any processing signal that triggers a computing device to perform the respective action.

The methods, systems and computer elements disclosed herein provide an efficient, sustainable and robust way for treating an agricultural field. In particular providing operation data for the second treatment device for the at least one section of the agricultural field based on the monitoring and treatment status associated with the at least one section avoids redundant operation and enables targeted operation. By considering the monitoring and treatment status from the first treatment device, the second treatment device can be operated to treat the specific section of the agricultural field based on the the monitoring and treatment status obtained by the first treatment device for that specific section. Overall this provides more tailored and more sustainable operation, since the second treatment device can treat based on the field data already acquired by the first treatment device. Multiple treatment devices can hence be operated in an efficient, quasi on-demand manner.

It is an object of the present invention to provide an efficient, sustainable and robust way of treating an agricultural field. These and other objects, which become apparent upon the following description, are solved by the subject matter of the independent claims. The dependent claims refer to preferred embodiments of the invention.

The term treatment device is to be understood broadly in the present case and comprises any device configured to treat an agricultural field. The treatment device may be configured to traverse the agricultural field. The treatment device may be a ground or an air vehicle, e.g. a rail vehicle, a robot, an aircraft, an unmanned arial vehicle (UAV), a drone, or the like. The treatment device may by equipped with one or more treatment unit(s) and/or one or more monitoring unit(s). The treatment device may be configured to collect field data via the treatment and/or monitoring unit. The treatment device may be configured to sense field data of the agricultural field via the monitoring unit. The treatment device may be configured to treat the agricultural field via the treatment unit. Treatment unit(s) may be operated based on monitoring signals provided by the monitoring unit(s) of the treatment device. The treatment device may comprise a communication unit for connectivity. Via the communication unit the treatment device may be configured to provide, receive or send field data, to provide, send or receive operation data and/or to provide, send or receive operation data.

Operation identifier is to be understood broadly in the present case and may refer to any identifier associated with an operation the treatment device may perform. The operation identifier may by a treatment operation identifier or a monitoring operation identifier.

Treatment operation identifier is to be understood broadly in the present case and may refer to data associated with an operation of the treatment device for treating the agricultural field, particularly based on a field condition of the agricultural field. A treatment operation identifier may indicate a treatment operation. Treatment operation identifier may refer to a class of treatment indications. Treatment indication may refer to e,g, seeding, harvesting, weed management, fungi management, insectizide management and the like. E.g. for weed management, treatment operation identifiers may be associated with herbizide A application, herbizide B application, herbizide C application. Treatment operation identifier may include any data for characterization, selection, activation or operation of the treatment device for treating the agricultural field.

Monitoring operation identifier is to be understood broadly in the present case and may refer to data associated with an operation of the treatment device for monitoring the agricultural field, particularly for collecting field data of the agricultural field. A monitoring operation identifier may indicate a monitoring operation. Monitoring operation identifier may be characterized by a monitoring type and/or a monitoring mode. Monitoring type may refer to a monitoring indication, such as plant sensing for weed treatment, soil sensing for seeding, and the like. Monitoring mode may refer to the mode or a class of modes for a single monitoring type. For plant sensing, modes may be weed image detection, crop image detection, fungi optical detection or the like. Monitoring operation identifier may include any data for characterization, selection, activation or operation of the treatment device for monitoring the agricultural field.

First treatment device and second treatment device is to be understood broadly in the present case and may refer to at least two different treatment devices for treating the field.

The first treatment device may be equipped with monitoring and/or treatment unit(s) different to the monitoring and/or treatment unit(s) of the second treatment device. The first treatment device may be part of a group of first treatment devices. The second treatment device may be part of a group of second treatment devices. A group of treatment devices may refer to multiple treatment devices equipped with monitoring and/or treatment units of equal type or mode.

The term treatment is to be understood broadly in the present case and may relate to any treatment for the cultivation of plants. The term treating or treatment is to be understood broadly in the present case and may relate to any treatments of the agricultural field, such as for the cultivation of plants. Treatment may include any treatment to be conducted during a season on an agricultural field such as seeding, applying products, harvesting etc.

The term treatment product is to be understood broadly in the present case and may refer to any object or material useful for the treatment. In the context of the present invention, the term treatment product may include:
chemical products such as fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, or any combination thereof.
biological products such as microorganisms useful as fungicide (biofungicide), herbicide (bioherbicide), insecticide (bioinsecticide), acaricide (bioacaricide), molluscicide (biomolluscicide), nematicide (bionematicide), avicide, piscicide, rodenticide, repellant, bactericide, biocide, safener, plant growth regulator, urease inhibitor, nitrification inhibitor, denitrification inhibitor, or any combination thereof.
fertilizer and nutrient,
seed and seedling,
water, and
any combination thereof.

Distributed computing environment is to be understood broadly in the present case and may refer to a distributed machinery setup with multiple treatment devices for treating the agricultural field. The multiple treatment devices may be interconnected. The multiple treatment devices may be connected via one or more distributed computing device(s). The computing device(s) may be part of the treatment devices and/or remote from the treatment devices connected through a network.

Agricultural field is to be understood broadly in the present case and may refer to an agricultural field to be treated. The agricultural field may be any plant or crop cultivation area, such as a farming field, a greenhouse, or the like. It may also include any area to be treated such as a rail way, a street side stipes or the like. A plant may be a crop, a weed, a volunteer plant, a crop from a previous growing season, a beneficial plant or any other plant present on the agricultural field. The agricultural field may be identified through its geographical location or geo-referenced location data. A reference coordinate, a size and/or a shape may be used to further specify the agricultural field. The agricultural field may be identified through a reference coordinate and a field boundary.

Section of the agricultural field is to be understood broadly in the present case and may relate to at least one position or location on the agricultural field. The section may relate to a zone of the agricultural field including multiple positions or locations on the agricultural field. The section, e.g. the zone, may relate to multiple positions or locations forming a contiguous area of the agricultural field. The section may relate to distributed patches of the agricultural field multiple positions or locations on the agricultural field indicating a common field condition. The section may be analyzed indicating the field condition of the section. The section may include one or more position(s) or location(s) on the agricultural field flagged with one or more flags indicating the field condition. The agricultural field may comprise one or more sections. The sections may be related to field data, in particular field conditions. The section may be flagged. The section may be identified through its geographical location or geo-referenced location data. A reference coordinate, a size and/or a shape may be used to further specify the section. The section may be of sub-field resolution. The section may include space resolutions in the range of multiple hundred meters to a couple of millimeters, preferred a couple of meters to a couple of centimeters and more preferred multiple centimeters e.g. in the range of 1-300 cm, in the range of 10 to 200 cm, or in the range of 20 to 150 cm. The section refers to a sub-area or a geographical location or location coordinate of a sub-area of the agricultural field.

Field data is to be understood broadly in the present case and may comprise any data that may be obtained by the treatment device. Field data may be obtained from the treatment unit and/or the monitoring unit of the treatment device. Field data may comprise measured data obtained by the treatment device. Field data may comprise monitoring unit data configured to control or for controlling the monitoring unit of the treatment device. Field data may comprise treatment unit data configured to control or for controlling the treatment unit of the treatment device. Field data may comprise data from which a field condition on the agricultural field may be derived. Field data may comprise data related to an treatment and/or monitoring operation of the treatment device. Field data may comprise data from which a monitoring or treatment status of the at least one section may be derived. Field data may comprise image data, spectral data. section data based on which sections may be analysed or sections may be flagged with e.g. a monitoring or a treatment status, crop data, weed data, soil data, geographical data, trajectory data of the treatment device, measured environmental data (e.g. humidity, airflow, temperature, and sun radiation), and treatment data relating to the treatment operation. The field data may be associated with a section such as location or position in the agricultural field. Field data may be section specific such as location or position specific data associated with a specific section such as location or position in the agricultural field.

Field condition is to be understood broadly in the present case and may be associated with a condition of the agricultural field. The field condition may be part of the field data or derived from the field data. The field condition may relate to a section status associated with the section of the agricultural field. The field condition may be derived from measured monitoring unit data or treatment unit data. The field condition may include or indicate a monitoring status derived from measured monitoring unit data. The field condition may include to indicate a treatment status derived from treatment unit data. It may indicate a treatment or monitoring status based on the collected field data from which a condition of the agricultural field may be derived such as the presence of certain weeds, insects or fungis in sections of the agricultural field or the absence of any or any further weeds, insects or fungis to be treated. The field condition may relate to a monitoring or treatment status of the section of the agricultural field associated with the treatment device. A section status may be “to be treated”. “untreated” or “treated”. The status “to be treated” may relate to the detection of a field condition that signifies treatment by another device with different treatment mechanism. E.g. a weed, a fungi, a nutrient level, a water level, a growth stage or any another condition may be detected on the section, e.g. by the monitoring unit of the treatment device, that requires treatment. The status “treated” may relate to the treatment status of the section that indicates treatment was conducted by the treatment device. The status flag “untreated” may relate to the detection of a field condition or a monitoring status that indicates no treatment is required. Other stati may be used to indicate a status of a section.

Selection data as used herein is to be understood broadly in the present case and relates to any data configured to select the treatment device. The term selection data may refer to data configured to address one treatment device. Selection data may be used to address one treatment device for providing operation data.

Operation data as used herein is to be understood broadly in the present case and relates to any data configured to operate the treatment device. The term operation data may refer to data configured to operate at least one treatment device in relation to other treatment devices. In particular operation data may be a control signal configured to operate a treatment device or a control signal configured to operate a treatment device may be derived from operation data. The operation data may be configured to control one more technical means of the treatment device. The operation data may comprise data to control an treatment and/or monitoring unit of the treatment device. The operation data may be configured to control movement of the treatment device. The operation data may be configured to control a steering and drive unit of the treatment device. The operation data may be configured to control one treatment device in relation to other treatment devices.

Providing operation data based on the field data as used herein may relate to operation data that includes field data and/or is derived from field data. Operation data based on the field data may be provided to the second treatment device. Operation data based on the field data may further be provided to another treatment device. The providing of operation data based on the field data may include to determine operation data from field data.

The providing of selection or operation data may be carried out by one or more computing device(s) that determines or derives the operation data from the field data. The computing device may be part of the first treatment device and/or the second treatment device and/or any remote computing device. Providing may include any communication between interfaces of the distributed computing device(s) or any process making the result of a determination, generation, selection, sending or receiving available to any interface, hardware element or software element of the distributed computing device(s), or any internal interface, hardware element or software element implemented on the distributed computing device(s).

In one option operation data may be provided from the first treatment device to the second treatment device. The operation data for the second treatment device may be determined by the first treatment device based on the field data obtained or collected by the first treatment device or another treatment device. In another option field data obtained or collected by the first treatment device or another treatment device may be obtained by a remote computing device, operation data may be determined by the remote computing device and provided to the second treatment device. In yet another option field data obtained or collected by the first treatment device or another treatment device may be obtained by the second treatment device, operation data may be determined by the second treatment device e.g. by one of the computing units of the second treatment device, and provided to another computing unit of the second treatment device. In yet another option field data obtained or collected by the first treatment device or another treatment device may be obtained by the second treatment device, operation data may be determined by one computer element of the second treatment device and provided to another computer element of the second treatment device. In yet another option field data obtained or collected by the first treatment device or any other treatment device may be obtained by the remote computing device and/or any treatment device, operation data may be determined by the remote computing device and/or any treatment device and provided to the second treatment device. Similarly selection data may be provided in various forms.

In an embodiment field data may be obtained from a monitoring unit and/or a treatment unit attached to the at least first treatment device. The monitoring unit and/or the treatment unit may collect field data. The monitoring unit and/or the treatment unit may provide the field data collected.

Providing operation data associated with the at least one section of the agricultural field for the second treatment device may be based on the monitoring and treatment status associated with the at least one section and the first treatment device. Providing selection data for selecting the second treatment device associated with the at least one section of the agricultural field may be based on the field data associated with the at least one section and the first treatment device. Providing selection data for selecting the second treatment device associated with the at least one section of the agricultural field may be based on the field data, in particular a section status, more particular a treatment status or a monitoring status associated with the at least one section.

In a further embodiment at least one field condition for the section may be derived from field data. Providing selection or operation data may include determining or updating selection or operation data based on the at least one field condition associated with the section, e.g. a section status. A section associated with at least one field condition may also be referred to as analysed section.

In a preferred embodiment field data may be obtained for the section and operation or selection data are provided for the same section. In other words, field data is obtained for the first section and operation or selection data is provided for the first section. The field data and the operation or selection data may hence be associated with the same section.

In a further embodiment operation data may relate to a treatment and/or monitoring operation to be executed by the second treatment device on the section of the agricultural field. Such treatment and/or monitoring operation may be indicated or signified by treatment and/or monitoring operation indentifer associated with the second treatment device. In other words, the operation data may include an operation identifier indicating or signifying a treatment or monitoring operation for the second treatment device.

In a further embodiment the first operation identifier associated with the first treatment device may be different to the second operation identifier associated with the second treatment device. The second operation identifier may indicate at least one monitoring or treatment operation of the second treatment device different to at least one monitoring or treatment operation of the first treatment device. In other words, the first treatment device is configured to perform a first treatment operation on the agricultural field and the second treatment device is configured to perform a second treatment operation on the agricultural field. Additionally or alternatively, the first treatment device may be configured to perform a first monitoring or treatment operation on the agricultural field and the second treatment device may be configured to perform a second monitoring or treatment operation on the agricultural field. For instance, the second treatment device may comprise at least one second monitoring unit different to at least one first monitoring unit of the first treatment device. For instance, the second treatment device may comprise at least one second treatment unit different to at least one first treatment unit of the first treatment device. For instance, the second treatment device may comprise at least one second treatment product different to at least one first treatment product of the first treatment device.

In a further embodiment the operation data indicates or is associated with a sequential operation mode for a first group of first treatment devices and a second group of second treatment devices or a simultaneous operation mode for at least the first and the second treatment device. The operation data for at least the first and the second treatment device may include a time parameter indicating an operation start and/or an operation stop for the treatment operation. In the simultaneous operation mode, the time parameter may be equal for at least the first and the second treatment device or all treatment devices. In the sequential operation mode the time parameter may differ for at least the first and the second treatment device or for all treatment devices. In a mixed operation mode operation data may specify time parameters for different groups of treatment devices and may be associated with different treatment device identifiers. Operation data may indicate a first group of first treatment devices and a second group of second treatment devices to act sequentially, wherein the first group of first treatment devices operates simultaneously and the second group of second treatment devices act simultaneously. In other words, the group of first treatment devices may be operated in simultaneous operation mode and the group of second treatment devices may be operated in simultaneous operation mode, wherein the group of first treatment devices may be operated in a sequential operation mode with respect to the group of second treatment devices. This way the number of treatment devices operating on the field may be limited through the operation data simplifying the control of multiple treatment or monitoring actions for different sections of the field.

In one embodiment the methods disclosed herein further comprise providing initial operation data to at least the first treatment device and/or the second treatment device. Frist initial operation data may be provided to the first treatment device or a group of first treatment devices. Second initial operation data may be provided to the second treatment device or a group of second treatment devices.

In a further embodiment, initial operation data may include a starting position, an initial trajectory or initial instructions for trajectory determination. The trajectory may include location or position data for the movement of the treatment device on the agricultural field. The trajectory may include control data for the steering and drive units of the treatment device. Initial operation data may include initial monitoring unit data to operate monitoring unit(s) of the treatment device or initial treatment unit data to operate treatment unit(s) of the treatment device. Providing initial operation data allows for more efficient operation on start of the treatment of the agricultural field. If no initial operation data is provided, the multiple treatment devices may visit certain locations twice before respective operation data can be updated due to latencies in the computing and communication. This may cause redundancies and is particularly advantageous in central architectures with multiple interfaces to be orchestrated. Providing at least the starting points can reduce the number of correction maneuvers needed to avoid collisions. This is particularly advantageous in decentralized architectures with e.g. collectively self-organized swarms.

In a further embodiment by providing the operation data to the second treatment device, the operation data associated with the second treatment device may be dynamically adjusted during treatment operation of the second treatment device, preferably based on the provided field data from the first treatment device, in particular a field condition derived from the field data. Treatment operation may refer to operation on the agricultural field. Such dynamic adjustment of operation data allows for a self-organized operation of the treatment devices on the agricultural field based on the field conditions sensed on the field. As a result the treatment of the field can be executed in dynamic and flexible manner taking the real-time on-field conditions into account and increasing the reliability.

Providing operation data may include determining or updating a trajectory or a trajectory determination of the second treatment device based on the monitoring or treatment status of the first treatment device. Providing operation data may include determining or updating the trajectory based on field data or the field condition associated with the section. Providing operation data may include determining or updating instructions for trajectory determination based on field data or the field condition associated with the section. This way field data of the first device can be analyzed to directly impact operation of the second treatment device. For instance, if one position is treated by the first treatment device and the monitoring unit of the first treatment device does not detect a further field condition to be treated, such position can be flagged “treated” and deleted from the trajectory of the second treatment device, thus saving time and energy. For instance, if one position is untreated by the first treatment device and the monitoring unit of the first treatment device detected a further field condition to be treated, such position can be flagged “to be treated” and added to the trajectory of the second treatment device, thus allowing for more targeted operation.

Providing operation data may include determining or updating treatment unit data based on the field data or the field condition associated with the section. Providing operation data may include determining or updating instructions for determining treatment unit data based on the field data or the field condition associated with the section. The operation data may include data relating to the field condition. Such data may include a treatment status from a first treatment device, from which treatment unit data for the second treatment device may be determined. Metadata may include image data of the section or spectral data of the given section or any other measurement raw data from the monitoring unit of the first treatment device. The treatment status may be identified based on analysing the field data and the treatment unit data for the second treatment device may be determined. Treatment unit data may relate to the treatment type or mode. Treatment unit data may relate to control parameters of the second treatment device. E.g. it may relate to valve or nozzle control parameters for a spray unit to adapt e.g. application rate or voltage control parameters for an electrical system to adapt the strength of the electrical puls. Such embodiment is advantageous, if the treatment unit of the first treatment device is not equipped to treat the monitored field condition.

Providing operation data may include determining or updating monitoring unit data based on the field data or the field condition associated with the section. Providing operation data may include determining or updating instructions for determining monitoring unit data based on the field data or the field condition associated with the section. The operation data may include data relating to the field condition. Such data may include a confidence level related to the identification of the field condition. If the confidence level for identifying the field condition through the monitoring unit of the first treatment device is below a threshold, monitoring unit control data may be determined for the monitoring unit of the second treatment device. The monitoring unit of the second treatment device may be at least in part different to the monitoring unit of the first treatment device. This may relate to the hardware or the software setup of the monitoring units. For instance the monitoring unit of the first treatment device may have a different camera setup e.g. with regard to optical range or with regard to sensitivity. For instance the monitoring unit of the first treatment device may have a different identification module e.g. with regard to identification of weed classes, fungi classes or insect classes. The monitoring unit data may relate to operation settings of the hardware or software. E.g. the monitoring unit data may relate to the use of the identification module or specific settings of the hardware module. Such embodiment is advantageous, if the monitoring unit of the first treatment device is not equipped to monitor and analyze the field data with respect to a field condition with sufficient certainty.

In a further embodiment the first treatment device may be associated with a first operation identifier and the second treatment device may be associated with a second operation identifier. The operation identifier may indicate the hardware or software setup of the treatment device. The operation identifier may further be associated with a treatment device identifier. This way the treatment device may be characterized by a treatment device identifier and associated operation identifier signifying the hardware or software setup of the treatment device.

In a further embodiment providing selection data may include selecting a suitable second treatment device for treating the at least one section of the agricultural field field based on the field data obtained from the first treatment device. Selection data may include treatment device identifier(s) and/or treatment or monitoring operation identifier(s) associated with the treatment device. Providing the selection data may include selecting the suitable second treatment device based on the field data obtained from the first treatment device, in particular based on the field condition derived from the field data, more particular based on the treatment and/or monitoring status derived from field data.

In other words, the providing unit may be configured to provide selection data including selecting a suitable second treatment device for treating the section of the agricultural field. In other words, the providing unit may be configured to select a suitable second treatment device based on the field data obtained from the first treatment device, in particular based on the field condition derived from the field data, more particular based on the treatment and/or monitoring status derived from field data.

In a further embodiment providing selection data may include matching an operation identifier associated with the second treatment device with a field condition determined from field data. This may include matching the field condition, more particular the section status, such monitoring and/or treatment status, with the operation identifier associated with the second treatment device. The operation identifier may be the treatment operation identifier or the monitoring operation identifier associated with the second treatment device. The monitoring status may be matched with the treatment and/or monitoring operation identifier. The treatment status may be matched with the treatment and/or monitoring operation identifier.

In a further embodiment matching may include operation identifiers of a subset of treatment devices for treating the agricultural field. Such subset of treatment devices may include treatment devices in a pre-defined local range or in a communication range of the first treatment device. This is beneficial to realize decentralized architecture with self-organized treatment device operation.

In a further embodiment providing selection data includes selecting a second treatment device based on a cost function relating to a distance to the section e.g. to be treated or monitored as indicated by a section status, or an operation identifier, such as the monitoring or treatment operation identifier.

In a further embodiment providing selection data includes selecting a second treatment device based on a section status as determined from field data provided by the first treatment device. The section status may signify e.g. an untreated, a to be monitored or a to be treated section. The section status may be provided by or derived from the field data. It may be provided as metadata to the section location. The section status may be matched with the operation identifier indicating treatment or monitoring operation associated with each treatment device.

The section status may indicate a section to be treated by a treatment operation different to the treatment operation provided by the first treatment device. Such section status may be matched with treatment operation identifiers of other treatment devices. The section status may indicate a section to be monitored by a monitoring operation different to the monitoring operation provided by the first treatment device. Such section status may be matched with monitoring operation identifiers of other treatment devices. This way the treatment device suitable or best suited for treating or monitoring the identified section status in some embodiments with a position closest in distance to the section may be selected.

In a further embodiment providing the selection data may be based on a mission schedule, wherein the mission schedule includes an allocation and/or availability of the second treatment device and/or other treatment devices for treating the agricultural field. This is beneficial to realize a central architecture with a remote computing device controlling operation of the treatment devices. The mission schedule may comprise identification data that includes device identifiers for first treatment device(s), second treatment device(s), other treatment device(s) and operation identifiers for monitoring and/or treatment operation associated with each treatment device and/or operation data, preferably current operation data, for first treatment device(s), second treatment device(s), other treatment device(s).

In a further embodiment the mission schedule may include initial operation data, which includes a starting position, an initial trajectory or initial instructions for trajectory determination. The initial operation data may be based on spatial coordinates and a spatial field layout with unmonitored parts and initial operation data for each treatment device to be operated on the agricultural field. The initial operation data may include spatial starting positions and initial operation data for each treatment device. The initial operation data may be updated during treatment of the agricultural field.

In a further embodiment providing selection or operation data includes dynamic adjustment of the number of first treatment device(s), second treatment device(s) and/or further treatment device(s) used for treating the agricultural field during treatment. Providing selection data may include or be followed by providing operation data. Adjustment of the number of devices may be based on the mission schedule e.g. in a central architecture. Such adjustment may be based on a negotiation mechanism with the first treatment device or a master treatment device e.g. in a decentral architecture.

The selection data or the operation data may be determined based on a self-organized operation mode. Such mode may be realized through swarm algorithms or fuzzy logic algorithms. The selection or the operation data may be determined by a self-organization algorithm such as a swarm algorithm or a fuzzy logic algorithm. Such determination may include determining the trajectory of each treatment device based on the monitoring or treatment status of other treatment devices. The treatment devices may be operated in a self-organized mode. This may include the monitoring and treatment status of the first treatment device for determining selection or operating data for the second treatment device.

The methods disclosed herein may further comprise the step of forwarding the field data and/or the operation data to a remote computing device for storing the field data and/or the operation data for further data processing. Owing to the limited storage capacity of treatment devices and the utilization of big data to enhance treatment operations on the field, remote storage capacity is beneficial. To reduce impact of such forwarding on processing capacities. forwarding may be done through batch data processing.

The systems and computer elements disclosed herein may further be configured to execute the methods described above. The systems may be configured to provide operation data via a cloud environment or a ground station e.g. in a centralized architecture and/or directly from treatment device to treatment device e.g. in a decentralized architecture. The systems may be configured to analyse field data and to provide the result of such analysis via the cloud environment or the ground station e.g. in a centralized architecture and/or via any treatment device e.g. in a decentralized architecture. The systems may be configured to select a suitable second treatment device via the cloud environment or the ground station e.g. in a centralized architecture and/or via any treatment device e.g. in a decentralized architecture. The systems may be configured to determine and/or provide operation data based on a mission schedule via the cloud environment or the ground station e.g. in a centralized architecture and/or directly via any treatment device e.g. in a decentralized architecture. The systems may be configured to dynamically adjust upon providing the operation data the number of first treatment device(s) and/or second treatment device(s) used for treating the agricultural field.

### BRIEF DESCRIPTION OF THE DRAWINGS

In the following, the present disclosure is further described with reference to the enclosed figures:

FIG. 1 illustrates an example embodiment of a system with multiple UAVs for treatment of an agricultural field;

FIG. 2 illustrates a central architecture with ground station as master;

FIG. 3 illustrates the central architecture with a master UAV;

FIG. 4 illustrates a decentral architecture with two self-organized UAVs;

FIG. 5 illustrates the decentral architecture with three self-organized UAVs;

FIG. 6 illustrates the decentral architecture with two UAVs and a field sprayer in self-organized arrangement;

FIG. 7 illustrates the decentral architecture with one UAV, one robot and the field sprayer in self-organized arrangement;

FIG. 8 illustrates the UAV adapted for treating the agricultural field;

FIG. 9 illustrates the ground robot adapted for treating the agricultural field;

FIG. 10 illustrates the field sprayer adapted for treating the agricultural field via spot-spraying;

FIG. 11 illustrates a block diagram of example computing components of a treatment device, such as the UAV, the robot, the field sprayer illustrated in FIGS. 8, 9 and 10;

FIG. 12 illustrates a block diagram of an exemplarily system architecture of a treatment device management system;

FIG. 13 illustrates a block diagram of another exemplarily system architecture of a treatment device management system;

FIG. 14 illustrates a block diagram of of another exemplarily system architecture of a treatment device management system;

FIG. 15 illustrates a flow diagram of an example method for providing operation data for treatment devices for treating an agricultural field;

FIG. 16 illustrates a flow diagram of a further example method for providing selection and operation data for treatment devices;

FIG. 17 illustrates a data flow diagram of an example method for providing selection and operation data for treatment devices;

FIG. 18 illustrates a data flow diagram of a further example method for providing selection and operation data for treatment devices.

### DETAILED DESCRIPTION OF EMBODIMENT

The disclosure is based on the finding that agricultural fields comprise heterogeneous characteristics (e.g. plant, weed, soil, etc.) distributed over the entire agricultural field. These characteristics are not permanent and therefore not completely known before the treatment devices treat the agricultural field. By monitoring with means of a treatment device during a treatment process of an agricultural field, these specific characteristics of the agricultural field are at least partly revealed. The collected information about these specific characteristics serves to beneficially improve the treatment strategy of one or more further treatment devices. By doing so, it is possible to (re-) act on changing conditions in the agricultural field on demand. In other words, the method collects field data via means of the first and/or further treatment devices passing through the agricultural field and provides operation data based on the field data to the second and/or further treatment devices. This enables a demand driven treatment of the agricultural field with a plurality of treatment devices and advantageously increases the treatment efficiency.

The following embodiments are mere examples for implementing the methods, the systems or the computer elements disclosed herein and shall not be considered limiting.

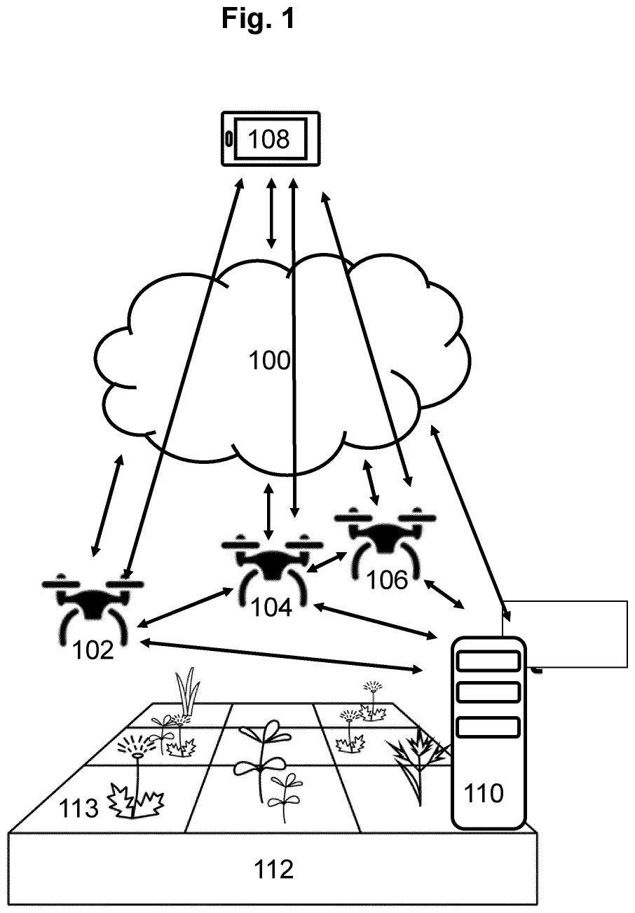

FIG. 1 illustrates an example embodiment of a system with multiple UAVs 102, 104, 106 for treatment of the field 112.

The system of FIG. 1 shows the distributed system including multiple UAVs 102, 104, 106, one or more ground station(s) 110, one or more user device(s) 108, and a cloud environment 100. The UAV 102, 104, 106 is an unmanned aerial vehicle, which can be controlled autonomously by onboard computers, remotely by a pilot controller as user device 108 or partially remotely e.g. by way of initial operation data.

The UAVs 102, 104, 106 may transmit data signals collected from various onboard sensors and actors mounted to the UAVs 102, 104, 106. Such data may include current flight data such as current altitude, speed, battery level, position, weather or wind speed, field data or location data. The UAVs 102, 104, 106 may directly or indirectly send data signals, such as field data or operation data, to the cloud environment 100, the ground station(s) 110, the user device(s) 108 or other UAVs 102, 104, 106. The UAVs 102, 104, 106 may directly or indirectly receive data signals, such as field data or operation data, from the cloud environment 100, the ground station(s) 110. the user device(s) 108 or other UAVs 102, 104, 106.

The cloud environment 100 may facilitate data exchange with and between the UAVs 102, 104, 106, the ground control station(s) 110, and user device(s) 108. The cloud environment 100 may be a server-based distributed computing environment for storing and computing data on multiple cloud servers accessible over the internet. The cloud environment 100 may be a distributed ledger network that facilitates a distributed immutable database for transactions performed by UAVs 102. 104, 106, one or more ground station(s) 110, the user device(s) 108 or one or more user device(s) 108. Ledger network refers to any data communication network comprising at least two network nodes. The network nodes may be configured to a) request the inclusion of data by way of a data block and/or b) verify the requested inclusion of data to the chain and/or c) receiving chain data. In such a distributed architecture, the UAVs 102, 104, 106, one or more ground station(s) 110, one or more user device(s) 108 can act as nodes storing transaction data in data blocks and participating in a consensus protocol to verify transactions. If the at least two network nodes are in a chain the ledger network may be referred to as a block chain network. The ledger network 100 may be composed of a blockchain or cryptographically linked list of data blocks created by the nodes. Each data block may contain one or more transactions relating to field data or operation data. Blockchain refers to a continuously extendable set of data provided in a plurality of interconnected data blocks, wherein each data block may comprise a plurality of transaction data. The transaction data may be signed by the owner of the transaction and the interconnection may be provided by chaining using cryptographic means. Chaining is any mechanism to interconnect two data blocks with each other. For example, at least two blocks may be directly interconnected with each other in the blockchain. A hash-function encryption mechanism may be used to chain data blocks in a blockchain and/or to attach a new data block in an existing blockchain. A block may be identified by its cryptographic hash referencing the hash of the preceding block.

Communication channels between the devices 102, 104, 106. 108, 110, and communication channels between the devices 102, 104, 106, 108, 110 and the cloud environment 100 may be established through a wireless communication protocol. A cellular network may be established for UAV 102, 104, 106 to UAV 102, 104, 106, UAV 102, 104, 106 to ground station 110, UAV 102. 104, 106 to cloud environment 100 or ground station 110 to cloud environment 100 communication. Such cellular network may be based on any known network technology such as SM, GPRS, EDGE, UMTS/HSPA, LTE technologies using standards like 2G, 3G, 4G or 5G. In a local area of a field 112 a wireless local area network (WLAN), e.g. Wireless Fidelity (Wi-Fi), may be established for UAV 102, 104, 106 to UAV 102. 104, 106 or UAV 102, 104, 106 to ground station 110 communication. The cellular network for UAV 102, 104, 106 to UAV 102, 104, 106 or UAV 102, 104, 106 to ground station 110 may be a Flying Ad Hoc Network (FANET). The UAVs 102, 104, 106 and the ground control station(s) 103 may share data signals with the user device(s) 108, such as a remote control for the UAVs 102, 104, 106, indirectly via the cloud environment 100 or directly. The user device(s) 108, such as a remote control for the UAVs 102, 104, 106, may be part of the cellular network, preferably the local network.

The first UAV 102 may be configured to perform a first treatment operation. The second UAV 104 may be configured to perform a second treatment operation. The third UAV 104 may be configured to perform a third treatment operation. Preferably UAV 102, 104, 106 treatment operation may differ with respect to the treatment type or the treatment mode. The term treatment type relates to the used application principle. The treatment type may comprise seeding, harvesting, chemical application or the like. The treatment mode for chemical application may be a spray mode (e.g. flat, spot, variable rates), for mechanical applications may be a removal mode (e.g. grabber, cutter), for electrical applications may be electrical application mode (e.g. laser, voltage pulse). The term treatment type may also relate to a insect, fungi or weed class and corresponding treatment product classes.

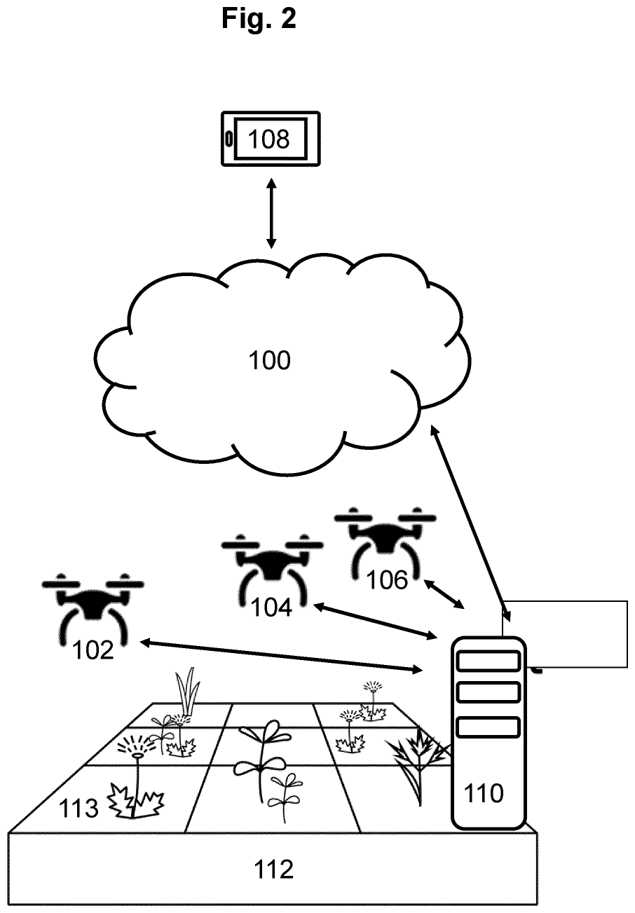

FIG. 2 illustrates the central architecture with ground station 110 as master.

In the shown arrangement, the UAVs 102, 104, 106 as well as the remote control 108 communicate with and via the ground station 110. A local WLAN network in the area of the field 112 enables such communication. The mission control of the UAVs 102, 104, 106 may be executed by the ground station 110 providing respective operation data to the UAVs 102, 104, 106. Via the remote control 108 a user can monitor or control the UAVs 102, 104. 106. The ground station 110 may stream data to the cloud environment 100 after or during treatment operation on the field 112.

The UAVs 102, 104, 106 may carry different treatment unit(s) and monitoring unit(s) to collectively treat the field 112. For example: The UAVs 102, 104, 106 may carry a imaging unit for monitoring the field 112. UAV 102 may carry a chemical treatment unit with first spray nozzles for spot spray. UAV 104 may carry a mechanical treatment unit with a grabber. UAV 106 may carry an electrical treatment unit with electrical pulse arrangement.

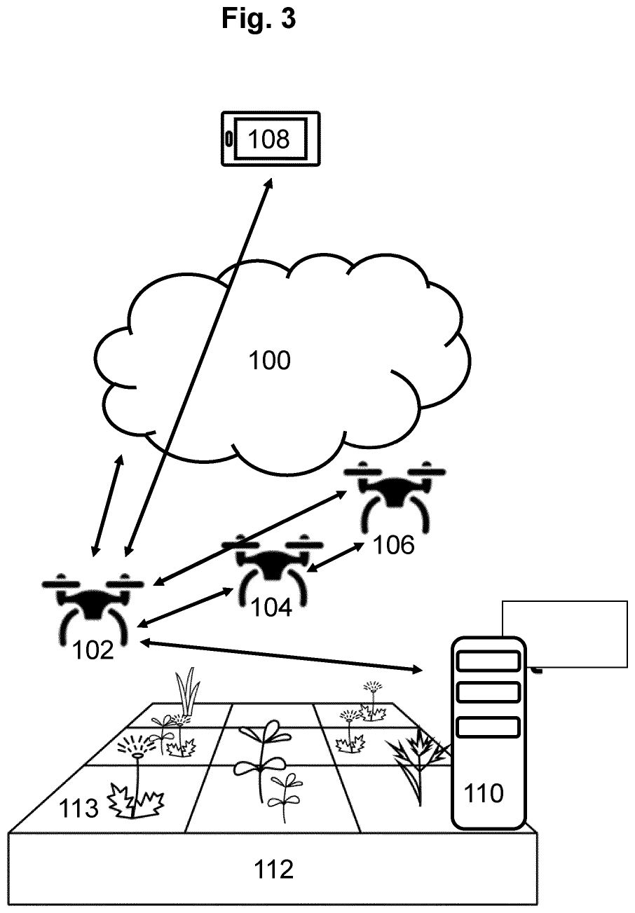

FIG. 3 illustrates the central architecture with the master UAV.

In the shown arrangement, the UAVs 104, 106, the remote control 108, the ground station 110 communicate with and via the master UAV 102. A local WLAN network in the area of the field 112 enables such communication. The mission control of the UAVs 102, 104, 106 may be executed by the master UAV 102 providing respective operation data to the UAVs 104, 106. Via the remote control 108 a user can monitor or control the UAVs 102, 104, 106.

The UAVs 102, 104, 106 may carry different treatment unit(s) and monitoring unit(s) to collectively treat the field 112 as for instance described in FIG. 2.

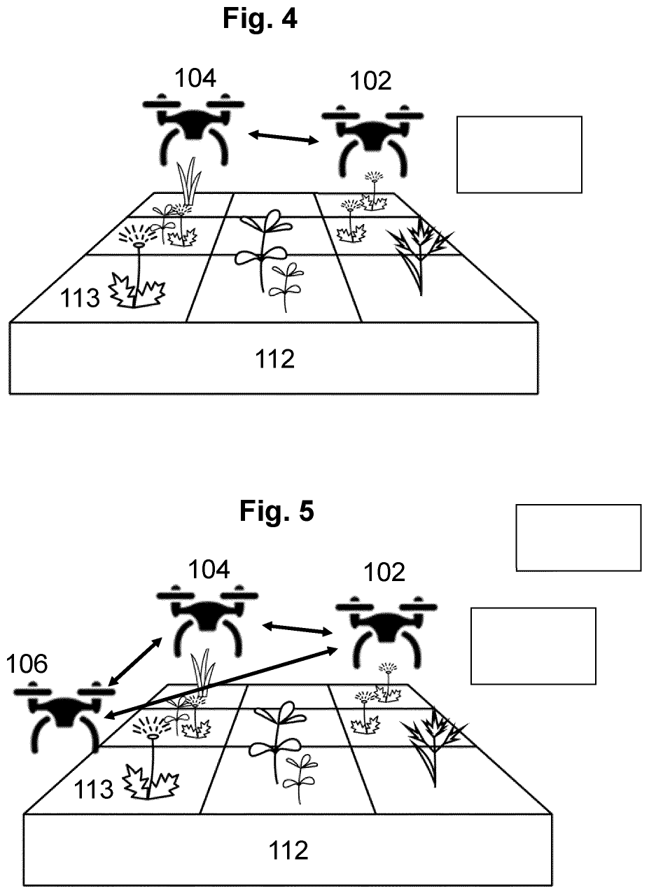

FIG. 4 illustrates the decentral architecture with two self-organized UAVs.

In the shown arrangement, the UAVs 102, 104 communicate with each other. A FANET enables such communication. The mission control of the UAVs 102, 104 may be self-organized by a negotiation and handover protocol established between the UAVs 102, 104. Via the remote control 108 a user can monitor or control the UAVs 102, 104.

The UAVs 102, 104, 106 may carry different treatment unit(s) and monitoring unit(s) to collectively treat the field 112 as for instance described in FIG. 2.

FIG. 5 illustrates the decentral architecture with three self-organized UAVs.

In contrast to the setup of FIG. 4, the arrangement of FIG. 5 includes the third UAV 106. The UAV 106 may be operated in sequential mode to the first and the second UAV 102, 104. This way the UAVs 102, 104 can treat the field 112 and monitor field conditions during treatment. Based on such monitoring the respective sections 113 may be provided to UAV 106 for subsequent treatment after the first and second UAV 102, 104 completed treatment of the field 112. Alternatively, the UAV 106 may be operated in simultaneous mode with the first and the second UAV 102, 104. This way the UAVs 102, 104 can treat the field 112 and monitor field conditions during treatment. Based on such monitoring the respective sections 113 may be provided to UAV 106 while the first and second UAV 102, 104 treat the field 112.

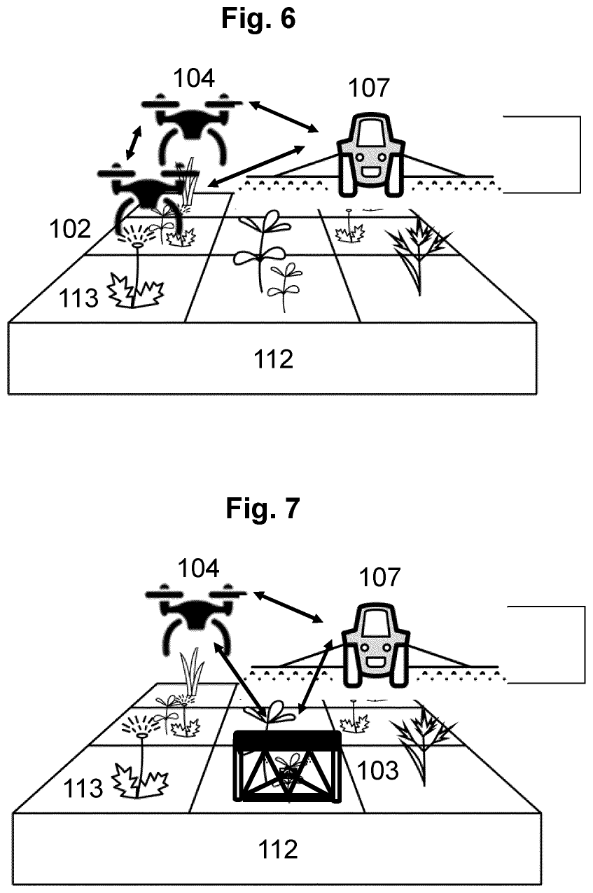

FIG. 6 illustrates the decentral architecture with two UAVs 102, 104 and a field sprayer 107 in self-organized arrangement.

In contrast to the setup of FIGS. 4 and 5, the arrangement of FIG. 6 includes the field sprayer 107 with a boom of spray nozzles for treatment product application. The field sprayer 107 is a tractor-based system with a spray boom. In other embodiments the tractor-based system may be equipped with a harvester or a seeder boom.

The UAVs 102, 104 and the field sprayer 107 may carry different treatment unit(s) and monitoring unit(s) to collectively treat the field 112 as for instance described in FIG. 2.

FIG. 7 illustrates the decentral architecture with one UAV 104, one robot 103 and the field sprayer 107 in self-organized arrangement.

In contrast to the setup of FIG. 6, the arrangement of FIG. 7 includes the robot 103. The robot 103 is comparable to the UAV 104, but ground based rather than air based. Using the robot 103 in addition to the UAV 104 has the advantage that the robot 103 has a stable distance to the ground and may easier to handle for ground based treatment operations like grabbing or cutting.

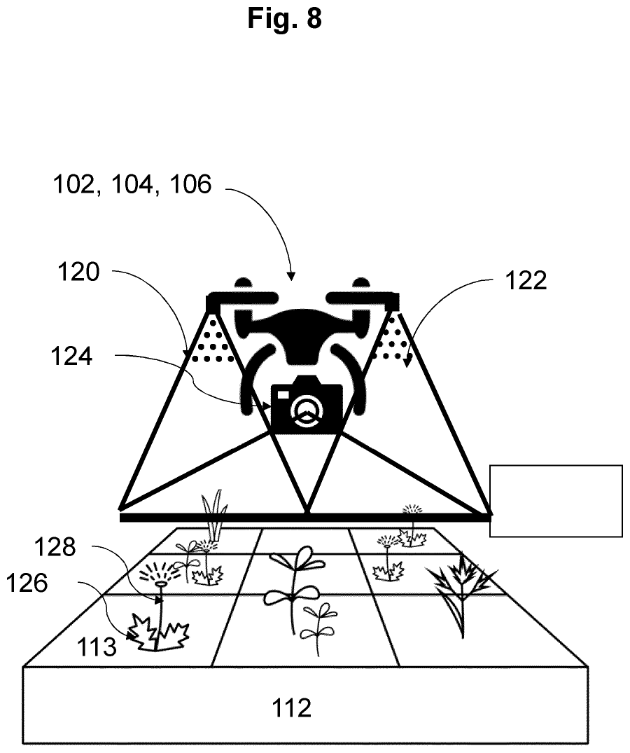

FIG. 8 illustrates the flying UAV 102, 104, 106 adapted for treating the field 112.

The UAV 102, 104, 106 shown in this example includes a camera as monitoring unit 124 for collecting field data and two spray nozzles as treatment units 120, 122 for spraying treatment product. The spray nozzles 120, 122 are in fluid connection to at least one tank carried by the UAV 102, 104, 106. Such set up allows for more efficient and targeted field treatment, since depending on the collected field data and the monitored field condition(s) the treatment units 120, 122 may be triggered to treat the field 112. Both operations may be executed while the UAV 102, 104, 106 hovers over the respective field section 113. In other embodiments, the UAV 102, 104, 106 may be a scouting UAV 102, 104, 106 including the monitoring unit 124 for collecting field data and monitoring field condition(s). In other embodiments the UAV 102, 104, 106 may be a spray UAV 102, 104, 106 including the treatment unit 120, 122 for spraying treatment product.

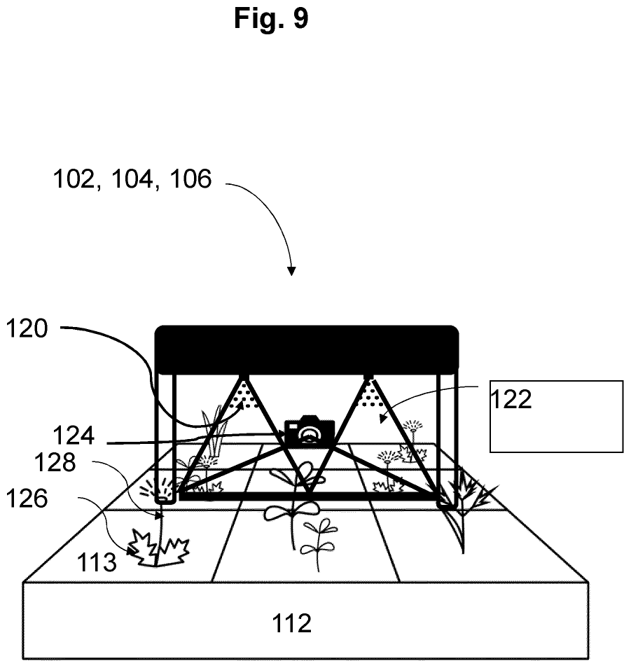

FIG. 9 illustrates a ground robot 103 adapted for treating the field 112.

In contrast to the UAV 102, 104, 106 of FIG. 8, the treatment device 103 of FIG. 9 is ground based and traverses on the ground. As shown in this example the robot 103 includes a monitoring unit 124 for collecting field data and monitoring field condition(s) and spray nozzles 122, 124 as treatment unit for spraying treatment product. The spray nozzles 120, 122 are in fluid connection to at least one tank carried by the robot 103. In other embodiments the robot 103 may be a scouting robot 103 including the monitoring unit 124 for collecting field data and monitoring field condition(s). In other embodiments the robot 103 may be a spray robot 103 including the treatment unit 122, 120 for spraying treatment product.

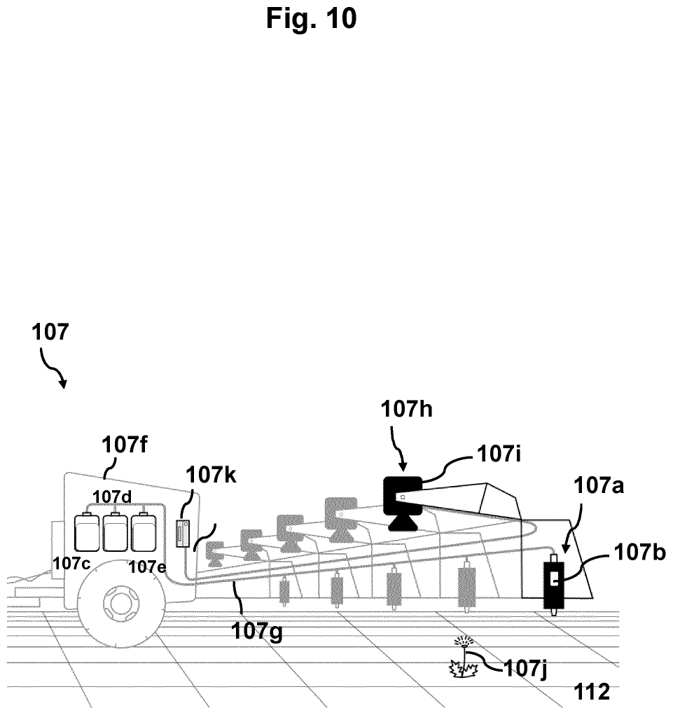

FIG. 10 illustrates the field sprayer 107 adapted for treating the field 112 via spot-spraying.

FIG. 10 shows an example of a large-scale treatment device such as the field sprayer 107, that includes spray nozzles 107a as treatment units. It is noted that FIG. 10 is merely schematically illustrating main components, wherein the field sprayer 107 may comprise more or less components than shown.

The field sprayer 107 may be part of the system shown in FIG. 1 and configured to apply treatment product to the field 112 or to one or more subareas thereof. The field spray 107 may be releasably attached or directly mounted to a tractor. In at least some embodiments, the field sprayer 107 comprises a boom with multiple spray nozzles 107a arranged along the boom. The spray nozzles 107a may be fixed or may be attached movably along the boom in regular or irregular intervals. Each spray nozzle 107a may be arranged together with one or more, preferably separately, controllable valves 107b to regulate fluid release from the spray nozzles 107a to the field 112.

One or more tank(s) 107c, d, e are placed in a housing 107f and are in fluid communication with the nozzles 107a through one or more fluidic lines 107g, which distribute the one or more treatment product(s) or composition ingredients like water to the spray nozzles 107a. This may include chemically active or inactive ingredients like a treatment product or mixture, individual ingredients of the treatment product or mixture, a selective or non-selective treatment product, a fungicide, ingredients of a fungicide mixture, a plant growth regulator, ingredients of a plant growth regulator mixture, water, oil, or any other treatment product. Each tank 107c,d,e may further comprise a controllable valve to regulate fluid release from the tank 107c,d, e to the fluid lines 107g.

For monitoring and/or detecting, the field sprayer comprises a detection system 107h with multiple monitoring units 107i arranged along e.g. the boom. The monitoring units 107i may be arranged fixed or movable along the boom in regular or irregular intervals. The monitoring units 107i may be configured to sense field data and to derive one or more conditions of the field 107j. The monitoring units 107i may be optical components providing images of the field 112. Suitable optical monitoring components 107i are multispectral cameras, stereo cameras, IR cameras, CCD cameras, hyperspectral cameras, ultrasonic or LIDAR (light detection and ranging system) cameras. Alternatively or additionally, the monitoring components 107i may comprise further sensors to measure humidity, light, temperature, wind or any other suitable condition on the field 112.

In at least some embodiments, the monitoring units 107i may be arranged as shown in FIG. 2 with units 107i perpendicular to the movement direction of the treatment device 107 and in front of the nozzles 107a (seen from drive direction). In the embodiment shown in FIG. 10, the monitoring units 107i are optical monitoring units 107h and each monitoring unit 107i is associated with a single nozzle 107a such that the field of view comprises or at least overlaps with the spray profile of the respective nozzle 107a once the nozzle reach the respective position. In other arrangements each monitoring unit 107i may be associated with more than one nozzle 107a or more than one monitoring units 107i may be associated with each nozzle 107a.

The monitoring units 107i, the tank valves and/or the nozzle valves 107b are communicatively coupled to a control system 107k. In the embodiment shown in FIG. 10, the control system 107k is located in a main housing 107f and wired to the respective components. In another embodiment monitoring units 107i, the tank valves or the nozzle valves 107b may be wirelessly connected to the control system 107k. In yet another embodiment more than one control system 107k may be distributed in the device housing 107f and communicatively coupled to the monitoring units 107h, the tank valves or the nozzle valves 107b.

The control system 107k may be configured to control and/or monitor the monitoring components 107i, the tank valves or the nozzle valves 107b based on a control file or operation data provided by a control file and/or following a communication control protocol. In this respect, the control system 107k may comprise multiple electronic modules. One module for instance may be configured to control the monitoring units 107i to collect field data such as images of the field 112. A further module may be configured to analyze the collected field data such as the images to derive parameters for the tank or nozzle valve control 107b. A further module may be configured to receive the operation data to derive a control signal. Yet further module(s) may be configured to control the drive system, the tank valves and/or nozzle valves 107b based on such derived control signal.

As described above, the field sprayer 107 comprises or is communicatively coupled to the monitoring units 107i, such as image capturing devices 107i, and is configured to provide one or more images of the area of interest to the control system 107k, e.g. as image data which can be processed by a data processing unit. It is noted that both capturing the at least one image by the monitoring unit 107i and processing the same by the control system 107k is performed onboard or through communication means during operation of the field sprayer, i.e. in real-time. It may further be noted that any other dataset than image data from which field conditions are derivable may be used.

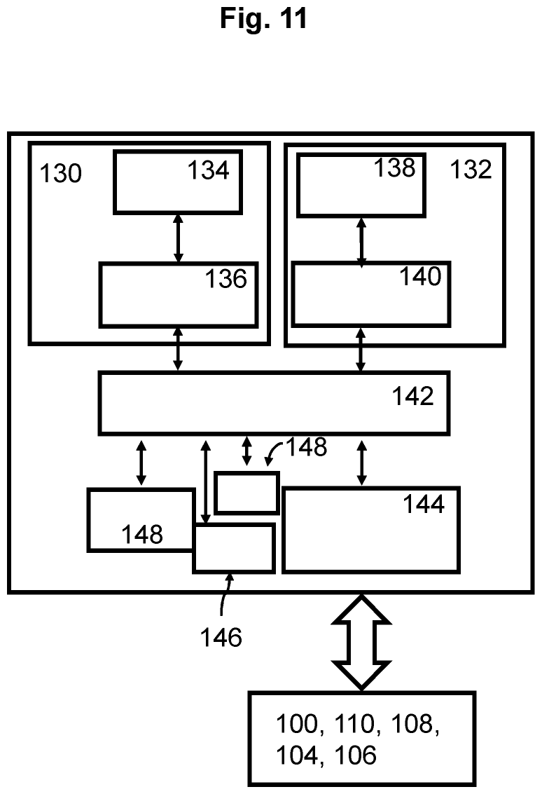

FIG. 11 illustrates a block diagram of example internal components of the treatment device 102, 104, 106, 107, such as the UAV, the robot or the field sprayer 107 illustrated in FIG. 8, 9 or 10.

The treatment device 102, 103, 104, 106, 107 includes a treatment unit 130 including actuator(s) 134 and an actuator control 136. The actuator(s) may include engine actuators, steering actuators which may be used to maneuver the treatment device 102, 103, 104, 106, 107. The actuator(s) may include treatment actuators configured to treat the field 112 and to provide field data e.g. via the actuator control 136. The actuator control 136 may include subunits such as an obtaining unit, a providing unit or a control unit.

The treatment device 102, 103, 104, 106, 107 further includes a monitoring unit 132 with sensor(s) 138 and an sensor control 140. The sensor(s) 138 may include an accelerometer, a gyroscope, and a magnetometer which may be used to estimate acceleration and speed of the treatment device 102, 103, 104, 106, 107. The sensor(s) 138 may include field monitoring sensor(s) configured to sense field conditions and to provide field data. The sensor control 140 may include subunits such as obtaining unit, providing unit or control unit.

The treatment device 102, 103, 104, 106, 107 includes a mission controller 142 configured to control or monitor the mission of the treatment device 102. 103, 104, 106, 107 on the field 112. The mission controller 142 may further include subunits such as obtaining unit, providing unit or controlling unit.

The treatment device 102, 103, 104, 106, 107 also includes an onboard memory 148 for storing e.g. the mission schedule, the field data, the operation data or the like. The treatment device 102, 103, 104, 106, 107 further includes a positioning system 146 configured to provide the current position of the treatment device 102, 103, 104, 106, 107 such as a global positioning system (GPS) or a camera based positioning system e.g. based on optical flow. The treatment device 102, 103, 104, 106, 107 further includes a power supply or fuel tank 148 including e.g. fuel or a rechargeable battery and a battery controller. The battery controller may be configured to provide a remaining battery level e.g. prior to or during mission. The treatment device 102, 103, 104, 106, 107 may be provided with various levels of control ranging from fully autonomously via remotely by a pilot controller to partially remotely/autonomously e.g. by way of an initial mission schedule.

For communication with other devices such as the ground station 110 or other treatment devices 102, 103. 104, 106, 107 or the cloud environment 100 the treatment device 102, 103, 104, 106, 107 includes a wireless communication interface 144. The wireless communication interface 144 may be configured with one or more cellular communication circuitrie(s), such as 4G or 5G circuitry, or one or more short range communication circuitrie(s), such as Bluetooth or ZigBee interfaces. The wireless communication interface 144 enables communication with other devices of the distributed system, such as other UAVs 102, 103, 104, 106, 107, the ground station 110, the cloud environment 100 or a remote controller 108. The cloud environment 100 access may be provided via the communication interface 144 of the treatment device 102, 103, 104, 106, 107 or via a client device 108 such as the remote controller 108 of the treatment device 102, 103, 104, 106, 107 or via the ground station 110.

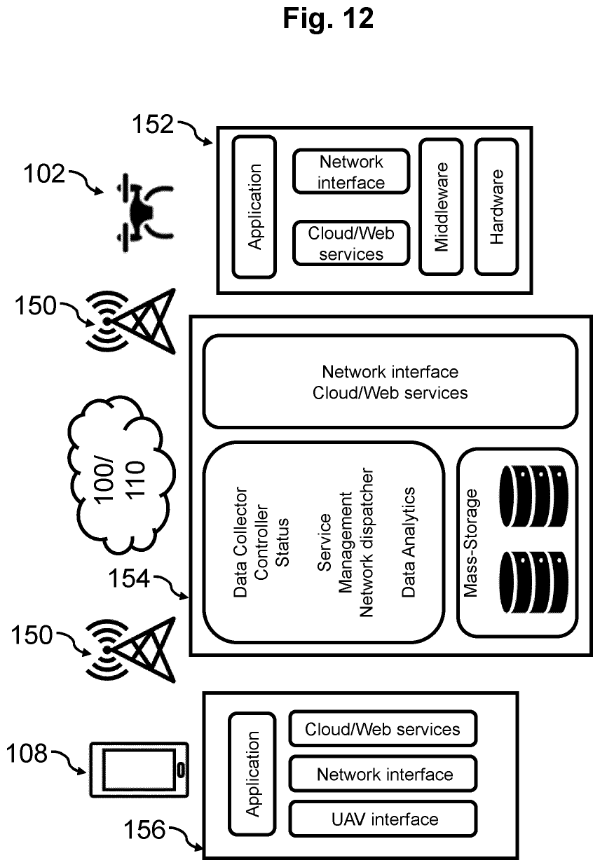

FIG. 12 illustrates a block diagram of an exemplarily system architecture of a treatment device 102 management system with the treatment device 102, the cellular network 150 and the cloud environment 100.

The treatment device 102 management system includes a treatment device layer 152 as part of the treatment device 102, a cloud service layer 154 associated with the remote computing devices and a remote control or client layer 156 associated with the client devices 108.

The treatment device layer 152 may be split into several hierarchical layers: the hardware, the middleware and the interface layer. The hardware layer relates to hardware resources such as sensors and actuators. The middleware relates to any suitable middleware for robotic operations. One example is the Robot Operating System (ROS) which provides different abstractions to hardware, network and operating system such as navigation, motion planning, low-level device control, and message passing. The communication layer relates to communication protocols. One communication protocol used in UAVs is for example MAVLink, which is built over different transport protocols (i.e. UDP, TCP, Telemetry, USB) that allow the exchange of messages between the UAV 102 and other devices. Such software architecture allows to control and monitor treatment devices 102 without having to interact with the hardware. An additional application layer allows to customize the functionalities provided by e.g. ROS to a) track the field operation of the treatment device 102, b) collect and/or analyze field data with respect to field conditions c) provide flagged sections and operation data, d) update the operation data for the treatment device 102, e) receive the operation data for the treatment device 102, f) stream field data to the ground station 110, the cloud environment 100 or the client device 108.

The cloud service layer 154 may include: a mass storage layer, the computing layer, the interface layer. The storage layer is configured to provide mass storage for streams of data provided by the treatment device 102. Each treatment device 102 may be configured to stream e.g. operation data, field data, control data and the like in real-time during field operation, intermittently in batches, or after field treatment. Such data may be stored in structured databases such as SQL databases or in a distributed file system such as HDFS, NoSQL database such as HBase. The computing layer may include an application layer that allows to customize the functionalities provided by standard cloud services to perform computing processes based on e.g. the field data, the operation data, the selection data, the mission schedule. Such functionalities may include a) streaming field data provided by the treatment device 102, b) analysing field data provided by the treatment device 102, c) determining or generating selection or operation data for the treatment device 102, d) updating selection or operation data for the treatment device 102, e) providing initial operation data for the treatment device 102, f) determining selection or operation data based on the mission schedule for the treatment device, g) determining field conditions or h) dynamically adjusting the number of treatment devices 102 active on the field 112. Such applications may require real-time application processing when new events are detected. Dynamic re-scheduling of the operation of treatment devices 102 on the field 112 may be used to ensure the optimality of the missions' executions after considering the new events. The interface layer may implement web services, network interfaces such as UDP or TCP or Websocket interfaces. Such interfaces may enable listening to JSON serialized messages sent from treatment devices 102 and handling streaming applications. In the context of UAV management, MAVLink messages may be received from the UAVs 102 through network interfaces (UDP or TCP), and then forwarded to the client devices 108 through Websockets for monitoring or remote control. While network interfaces (UDP or TCP) may be used to handle continuous streams, web services may be used for sending control commands to the treatment device 102 and getting information from the cloud environment 100 or the ground station 110.

The client layer 156 provides interfaces for both end-users and treatment device 102. For end-users, the client layer 156 may run client side Web applications, which provide interfaces to the cloud services layer 154 or the treatment device layer 152. Users may be provided access for registering multiple treatment devices 102, 104, 106, defining and modifying operation parameters and decision making based on data analysis provided by the cloud 100. The applications may be configured for users to monitor and control the treatment devices 102, 104, 106 and their operation remotely. The applications may provide the functionalities to connect/disconnect, use available physical treatment devices and their services, configure and control the operation on the field 112 and monitor the operation on the field 112.

It should be noted at this point, that the description applies to any distribution of processing steps carried out by different devices in the distributed system shown in FIG. 1. For instance the treatment device 102, 104, 106 may be configured to collect and provide field data or operation data to the cloud environment 100. Such data may be analysed e.g. for field conditions or used to determine e.g. the mission schedule or operation data in the cloud environment 100. The cloud environment 100 may provide the result of such analysis or determination to the treatment device 102, 104, 106 or to the client device 108. Alternatively the treatment device 102, 104, 106 may be configured to collect and analyse field data and/or to determine field conditions, or operation data. The result may be passes to the cloud environment 100, which may further process the result e.g. to update a mission schedule and/or provide the result to other treatment devices 102, 104, 106 or to the client device 108. Further alternatively, the treatment device 102, 104, 106 may be configured to collect and analyse field data and/or to determine field conditions or operation data. The result of such analysis or determination may be provided to other treatment devices 102. 104, 106 or the client device 108. The field data, the operation data and/or the result of any analysis may be streamed to the cloud environment 100 for storage purposes. The alternatives described here are only for illustration purposes and should not be considered limiting.

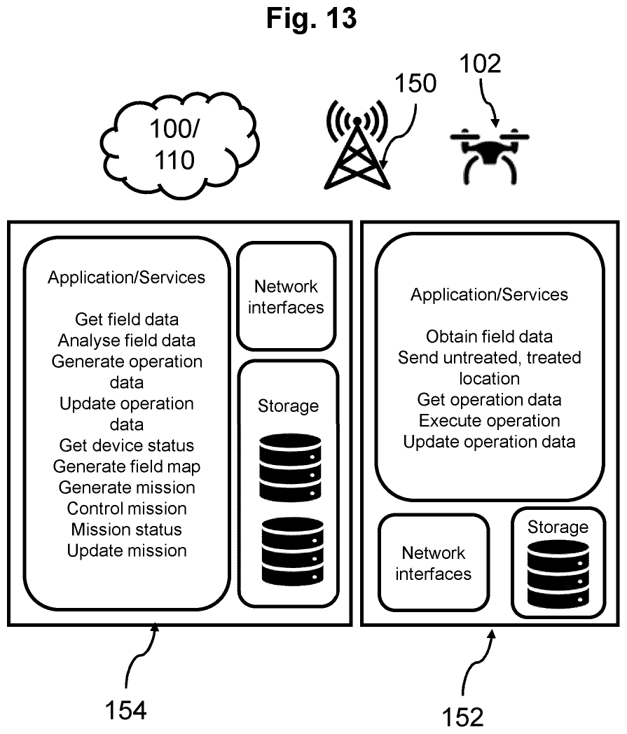

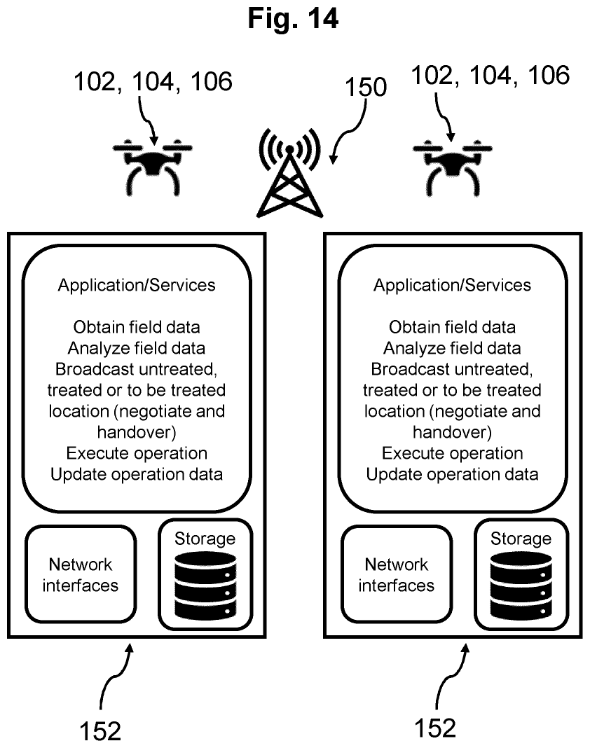

FIGS. 13 and 14 illustrate a block diagram of an example system architecture with centralized management system and decentralized management system based on self-organization.

In the centralized embodiment the treatment device 102 collects field data, analyses such field data and receives selection or operation data from the ground station 110 or the cloud environment 100. The ground station 110 or the cloud environment 100 stream field data from the treatment device 102, manage missions for the treatment devices 102, 104, 106, generate selection or operation data based on the mission schedule and update operation data based on the field data and the mission schedule.

In the de-centralized embodiment the treatment devices 102. 104, 106 collect field data, analyse such field data, generate or update selection or operation data and negotiate handovers with other treatment devices 102, 104, 106. In such embodiment a fully self-organized collective action of the treatment devices 102, 104, 106 on the field may be realized. For storage purposes the treatment devices 102, 104, 106 may stream data to the cloud environment 100 or the ground station 110. Further services described and shown in FIGS. 12 and 13 for the cloud environment 100 or the ground station 110 may be implemented on the treatment devices 102, 104, 106.

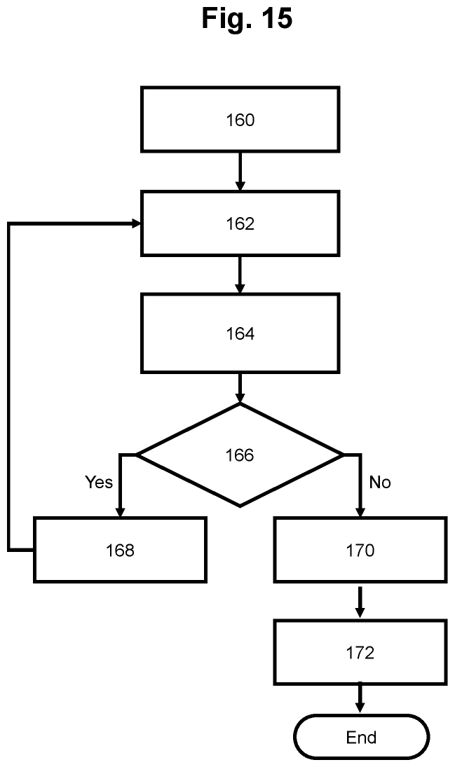

FIG. 15 illustrates a flow diagram of an example method for providing operation data for treatment devices 102, 104, 106 for treating the field 112.

The method steps shown in FIG. 15 may be executed by the first treatment device 102 or by the first treatment device 102 in combination the ground station 110, the cloud environment 100, at least one second treatment device 104, or any combination thereof. For ease of description, the following is related to the first treatment device 102 and the second treatment device 102 for treating the field 112. This should not be considered limiting and is applicable to a plurality of first and a plurality of second treatment devices 102, 104 as well as more than two types of treatment devices 106.

In a first step 160, initial operation data is provided to the first treatment device 102 and/or the second treatment device 104. The initial operation data may relate to the prescribed mission of the treatment devices 102, 104, 106 on the field 112. The operation data may for instance be provided in the form of a JSON file prepared by the cloud environment 100. The operation data may specify the treatment operation such as weed treatment, fertilizer treatment, disease treatment or the like. The operation data may specify the treatment time, the initial position or the initial trajectory, or the field 112 to be treated.

In a second step 162, the first treatment device 102 starts or continues its mission. The first treatment device 102 obtains field data for at least one section 113 of the field 112. The field data may be obtained by one or more monitoring unit(s) 132 such as one or more optical sensors. Some sensor examples are a RGB camera, a hyperspectral camera, an infrared sensor, a weed sensor, a disease sensor, a soil sensor, an airflow sensor, a radar sensor, a LIDAR sensor, a LADAR sensor, a humidity sensor, or a sun radiation sensor. The monitoring unit may include one or more sensors. The field data relates to a field condition sensed by the first treatment device 120.

In a third step 164. the field data obtained is analysed to identify one or more field condition(s). Such field condition may include a section status associated with the section 113 of the field 112. The section status may for instance be the monitoring status indicating that one or more weeds, fungi or insects are present in the field 112 and need to be treated.

In a fourth step 166, a treatment operation for each monitoring status “weed, fungi or insect to be treated” may be determined. Depending on the identified monitoring status, the onboard treatment unit may be selected and triggered. This may be done through a look-up table including treatment operation identifiers associated with the treatment unit and respective field conditions, specifically respective monitoring status. Hence, the applicability of the treatment unit 130 of the first treatment device 102 is checked in view of the monitoring status of the section.

If the identified monitoring status signifies the treatment unit 130 of the first treatment device 102 to be suitable for treating the associated monitoring status of the section 113 on the field 112, the treatment unit 130 of the first treatment device 102 is triggered in a fifth step 168. The treatment of the field section 113 results in step 168, that the treatment status is set to treated for the respective section 113. The treatment device then moves to the next section 113 and obtains field data in step 162. If no untreated field condition for a certain section 113 is detected, the first treatment device 102 stores the treated status optionally in connection with the section and further optionally updates a treated map mapping out the sections 113 visited by the first treatment device 102 with the associated section status. Such updated treatment map may be generated by the mission controller 142, the ground station 110, the cloud environment 100, other treatment device 104, 106 or a combination thereof. Further field data relating to the treatment operation executed by the first treatment device 102 in a certain section may be provided. Field data indicating completion of treatment for the respective section 113 may be stored. The field conditions representing, where treatment was executed e.g. as provided by the positioning system and the treatment unit(s) 130, may be stored in onboard memory 148 or broadcasted to the ground station 110, the cloud environment 100 or other treatment devices 104, 106.

Until the mission is completed such that treatment in sections 113 requiring treatment via the first treatment device 102 is executed, the first treatment device 102 obtains field data as lined out in the steps above. If the mission is completed the first treatment device 102 stops operation.

If the identified monitoring status signifies the treatment unit 130 of the first treatment device to be not suitable for treating the associated section 113 on the field 112, the treatment unit 130 of the first treatment device 102 is not triggered in a fifth step 168.

In step 170, the second treatment device 104 is selected for providing the operation data from the first treatment device 102. The operation data may include identifier(s) for field condition(s) in relation to field data sensed by the onboard monitoring unit, as equipped to the first treatment device 102, and in relation to onboard treatment mechanism(s), as equipped to the first treatment device 102. Such identifiers and relations to the field data or field conditions may be provided via a look-up table. This way the first treatment device 102 or the mission controller 142 of the first treatment device 102 can analyse the field data sensed by the respective monitoring unit 132 and select for any identified field condition(s) the applicable treatment unit(s) 130 of the first or any other treatment device 102, 104, 106. For instance, if a weed is detected in an image, the image is the field data collected by the first treatment device 102 and the weed identifier detected in such image is the field condition, specifically the monitoring status identified by the first treatment device 102. If the first treatment device 102 is not equipped with a treatment unit 130 to treat such weed, the weed identifier is not listed in the look-up table of treatment operation identifiers associated with the first treatment device 102. As a result the first treatment device will not treat such identified weed. The first treatment device selects or triggers to select based on the monitoring status and the look-up table with operation identifiers of other treatment devices a suitable second treatment device 104.

In step 172, the section 133 with its associated monitoring status as derived from field data obtained from the first treatment device 102 are send as operation data to the second treatment device 104.

This way the first treatment device 102 indirectly controls the mission of the second treatment device 104. The operation data sent to the second treatment device may include the coordinate of the section to be treated as identified by the first treatment device. It may further include treatment units data signifying which treatment unit 130 to be triggered for the associated section. If for instance the first treatment device 102 has detected monitoring status “weed, fungi or insect to be treated”, which the first treatment device 102 cannot treat the second treatment device 104 will treat such identified weed, fungi or insect.

In the example of FIG. 15, the section status untreated for a certain monitoring status triggers the first treatment device 102 to provide operation data to the second treatment device 104. Other stati like certain monitoring stati that need to be treated by the second treatment device 104 or that need to be monitored by the second treatment device 104 may be similarly applicable. If in the example of FIG. 15, no treatment unit 130 of the first treatment device 102 fits one of the identified field conditions to be treated, an untreated section 113 of the field 102 is identified, the section status is untreated. The field data signifying sections with untreated status may by provided to the further computing modules of the first treatment device 102, the second treatment device 104, to other treatment device(s) 104, 106, the ground station 110, the cloud environment 100, or a combination thereof.

If the untreated section status for a certain section 113 is set, operation data for the second treatment device 104 is provided. The operation data for the second treatment device 104 may be send to the second treatment device 104 and updated. Such updated operation data for the second treatment device 104 may be generated by the mission controller 142, the ground station 110, the cloud environment 100, other treatment device 104, 106 or a combination thereof. In such case the operation data is updated based on field data provided by the first treatment device 102. The update may include the section to be treated and optionally an identifier for the suitable treatment unit 130 of the second or any suitable treatment device 104. An updated trajectory of the second or any suitable treatment device 104 may be determined and the respective section 113 may be treated by the second or any suitable treatment device 104. The step of updating operation data may be performed by the first treatment device 102, by other treatment device(s) 104, 106, the ground station 110, the cloud environment 100, or a combination thereof.

This way the operation data for the second treatment device 104 for the at least one section of the field 112 is provided based on the monitoring and treatment status derived from field data for the at least one section 113 of the field 112 obtained by the first treatment device 102. The updated operation data for e.g. the second treatment device 104 equipped with a suitable treatment unit 130 is provided to the second treatment device 104. The updated operation data may be provided directly to the second treatment device 104 or the update may be performed by the second treatment device 104.

The operation data may relate to the treatment operation or the monitoring operation to be executed by the second treatment device 104 on the section 113 of the field 112. The operation may be signified by the operation identifier. The second operation identifier associated with the second treatment device 104 is hereby different to the first operation identifier of the first treatment device 102.

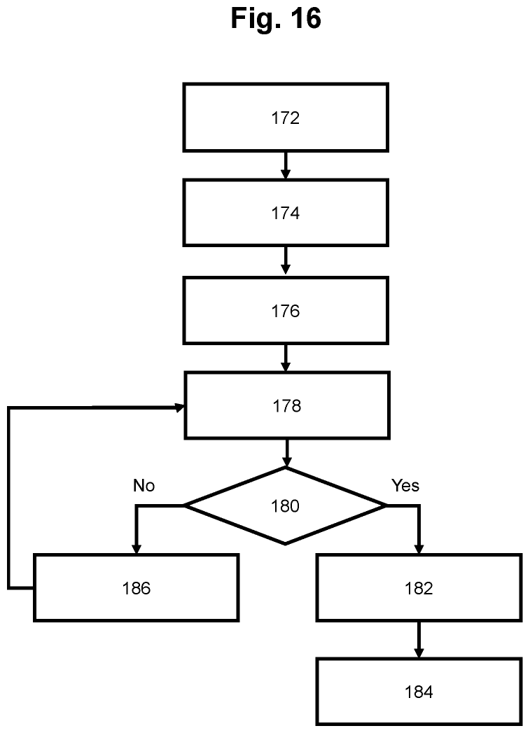

FIG. 16 illustrates a flow diagram of an example method for providing selection data for treatment devices 102, 104, 106 for treating the field 112.

As described in the context of FIG. 15, if an untreated location is identified by the first treatment device 102, such section status is provided in a first step 172 to the further computing modules of the first treatment device 102, the second treatment device 104, to other treatment device(s) 104, 106, the ground station 110, the cloud environment 100, or a combination thereof.

In the following steps 174 to 180, a suitable second treatment device 104, 106 for treating the at least one section 113 of the field 112 is selected and the operation data for the selected second treatment device 104 provided to such second treatment device 104.

In step 174, the allocation for suitable treatment devices 102, 104, 106 is determined to generate potential device identifiers for the selection data. Such determination may be based on a cost function. The cost function may relate to the distance to be traveled to the untreated section with the nearest treatment device 104, 106 relating to the lowest cost. The cost function may further relate to the treatment unit(s) 130 and the effectiveness or efficacy in treating the identified monitoring status or field condition. In such case the data provided by the first treatment device 102 may include the field condition identified rather than the suitable treatment unit identifier. The allocation and cost determination may be performed by the first treatment device 102. the second treatment device 104, other treatment device(s) 106, the ground station 110, the cloud environment 100, or a combination thereof.

In step 176, the treatment device identifier with the lowest cost is provided as selection data and may be selected. In step 178, the availability of the allocated device may be further validated. Such validation may be based on a mission schedule tracking of allocated and available treatment devices 102, 104, 106.

If the device 104 is available in 180, the available device 104 may be confirmed. In step 182, the mission schedule tracking allocated and available devices may be updated with respect to the selected and validated device 104.

In a last step 184, The operating data may be provided to the selected and validated device 104. The operation data relating to the treatment operation to be executed by the second treatment device 104 is hence provided to the second treatment device 104. Such operation data may include the section 113, an updated trajectory or trajectory determination, the field data or the field condition, the treatment unit identifier associated with the treatment unit 130 to be activated, the section 113 to activate such treatment unit 130 or any combination thereof. The operation data may be provided in real time e.g. by means of one master treatment device 102, 104, 106 to reduce latency. The operation data may be provided in batches e.g. by means of the cloud environment 100 or the ground station 110 to reduce bandwidth requirements. The operation data may be provided in real time through a handover directly between treatment devices 102, 104, 106.

If the selected device 104 is not available in 180, the device 106 with the next lowest cost is selected in step 186. The availability of the selected device 106 is validated. Such validation may be based on the mission schedule tracking allocated and available devices. If such device is available, the mission scheduled is updated accordingly. In a last step the operation data relating to the treatment operation to be executed by the second treatment device 104 is provided to the second treatment device 104.

In the scope of the method, the number of treatment devices 102, 104, 106 used for treating the field 112 may be dynamic. The number of treatment devices 102, 104, 106 may rise and may fall in dependency of e.g. availability of the treatment devices 102, 104, 106 and/or the remaining field area to be treated. E.g. in case a treatment device gets broken or runs out of battery the number decreases. E.g. in case the recharged treatment device can be used again the number increases. The treatment device may register and deregister itself in the network to which the method is applied. This may increase the flexibility of the method and decrease the adaption effort in case of changing numbers of treatment devices 102, 104, 106.

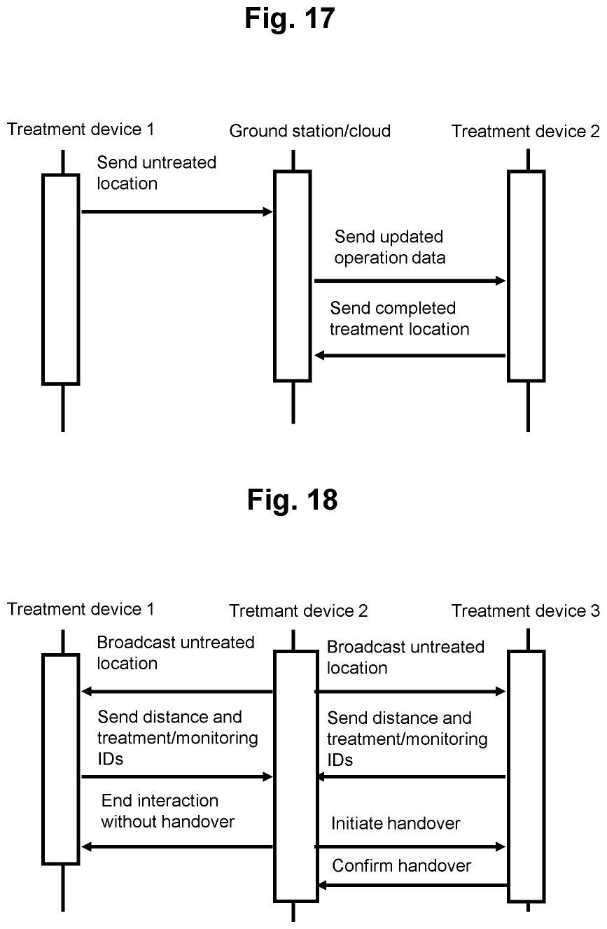

FIG. 17 illustrates one possible data flow diagram of a further example method for providing operation data for treatment devices for treating an agricultural field. Multiple other embodiments using different parts of the distributed computing environment may be possible.

As a first message, the first treatment device 102 pushes the field data for the untreated section to the ground station 110. The ground station 110 determines based on the field data the available second treatment device 104 and updates its operation data. The updated operation data is pushed to the second treatment device 104.

Once the treatment is completed the second treatment device 104 may push such update to the ground station 110 for updating the mission schedule tracking allocated and available devices. Once the second treatment device 104 completed its mission a respective message may be sent to the ground station 110. Upon validation the ground station 110 sends a return to home command, such that the second treatment device 102 stops further activity.

FIG. 18 illustrates one possible data flow diagram of a further example method for providing operation data for treatment devices for treating an agricultural field. Multiple other embodiments using different parts of the distributed computing environment may be possible.

As a first message, the first treatment device 102 broadcasts the field data for the untreated section to the other treatment devices 104, 106. The other treatment devices 104, 106 send their distance to the untreated section 113 and their monitoring/treatment ID. The first treatment device 102 selects one other treatment device 104. 106 based on a cost function. Upon such selection the first treatment device 102 initiates the handover with the selected treatment device 104, 106 and provides field data or operation data. The selected treatment device 104, 106 confirms such handover. To the non-selected treatment devices the first treatment device 102 broadcasts an end interaction message without handover.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer-implemented method for providing operation data for treatment devices (102, 104, 106, 107) on an agricultural field (112), wherein the treatment devices include at least a first treatment device (102) and a second treatment device (104) for treating the agricultural field, the method comprising:
obtaining field data for at least one section (113) of the agricultural field at least by the first treatment device, wherein the obtained field data indicates a monitoring and treatment status associated with the at least one section; and
based on the monitoring and treatment status associated with the at least one section, providing operation data associated with the at least one section of the agricultural field for the second treatment device.

2. The method according claim 1, wherein operation data relates to a treatment operation and/or a monitoring operation to be executed by the second treatment device on the at least one section of the agricultural field.

3. The method according to claim 1, wherein field data is obtained from a monitoring unit (132) and/or a treatment unit (130) attached to the at least first treatment device.

4. The method according to claim 1, wherein the operation data includes an operation identifier indicating a treatment or monitoring operation for the second treatment device.

5. The method according to claim 4, wherein a first operation identifier associated with the first treatment device is different to a second operation identifier associated with the second treatment device.

6. The method according to claim 1, wherein operation data indicates a sequential operation mode for a first group of first treatment devices and a second group of second treatment devices or a simultaneous operation mode for at least the first and the second treatment device.

7. The method according to claim 1, further comprising providing initial operation data to at least the first treatment device and/or the second treatment device.

8. The method according to claim 7, wherein initial operation data includes a starting position, an initial trajectory or initial instructions for trajectory determination.

9. The method according to claim 1, wherein by providing the operation data for the second treatment device, the operation data associated with the second device is dynamically adjusted during treatment operation.

10. The method according to claim 1, wherein at least one field condition (113) for the section is derived from field data, and wherein providing operation data includes determining operation data based on the at least one field condition (113) for the section.

11. The method according to claim 1, wherein field data is obtained for the section and operation data is provided for the same section.

12. A system for providing operation data for treatment devices (102, 103, 104, 106, 107) for treating an agricultural field (112), the system comprising:
at least a first treatment device (102, 103, 104, 106, 107) and a second treatment device (102, 103, 104, 106, 107) for treating the agricultural field (112);
an obtaining unit configured to obtain field data for at least one section (113) of the agricultural field (112) at least by the first treatment device (102, 103, 104, 106, 107), wherein the obtained field data indicates a monitoring and treatment status associated with the first treatment device (102, 103, 104, 106, 107) and the at least one section (113); and
a providing unit configured to provide operation data associated with the at least one section of the agricultural field (112) for the second treatment device (102, 103, 104, 106, 107) based on the monitoring and treatment status associated with the at least one section (113).

13. The system according to claim 12, wherein the first treatment device is configured to perform a first treatment operation and the second treatment device is configured to perform a second treatment operation.

14. A system for operating at least two treatment devices (102, 103, 104, 106, 107), the system comprising:
at least a first treatment device (102, 103, 104, 106, 107) and a second treatment device (102, 103, 104, 106, 107) for treating an agricultural field (112);
optionally a cloud environment (100) and/or a ground station (110); and
one or more computing device(s) configured to provide operation data, wherein the computing devices include instructions, which when executed on the one or more computing devices execute the following steps:
obtaining field data for at least one section of the agricultural field at least by the first treatment device, wherein the obtained field data indicates a monitoring and treatment status associated with the first treatment device and the at least one section; and
based on the monitoring and treatment status associated with the at least one section providing operation data associated with the at least one section of the agricultural field for the second treatment device.

15. Use of a treatment device (102, 103, 104, 106, 107) or a treatment product in a system according to claim 12.

16. A non-transitory computer-readable medium having instructions encoded thereon which, when executed on one or more computing device(s), cause the one or more computing device(s) to carry out the steps of the method according to claim 1.

17. Use of a treatment device (102, 103, 104, 106, 107) or a treatment product in a method according to claim 1.
